(19) United States
(12) Patent Application Publication
(10) Pub. No.: US 2010/0294989 A1
(43) Pub. Date: Nov. 25, 2010

(54) SMALL SCALE FUNCTIONAL MATERIALS

(76) Inventors: Edward O. Shaffer, II, Midland, MI (US); Joey W. Storer, Midland, MI (US); Leonardo C. Lopez, Midland, MI (US); Thomas H. Kalantar, Midland, MI (US)

Correspondence Address: The Dow Chemical Company;Brooks, Cameron, PLLC, 1221 Nicollet Avenue, Suite 500, Minneapolis, MN, 55403, US

(21) Appl. No.: 12/735,229

(22) PCT Filed: Nov. 21, 2008
(86) PCT No.: PCT/US2008/012986

§ 371 Date: Aug. 9, 2010

Related U.S. Application Data
(60) Provisional application No. 61/009,398, filed on Dec. 28, 2007.

(51) Int. Cl. C09K 19/52

(52) U.S. Cl. 252/299.01

(57) ABSTRACT

The disclosure provides for a small scale functional material, where the small scale functional material is imbibed with a material having a functionality response to an externally applied field.

### FIELD OF THE DISCLOSURE

The disclosure relates to a small scale functional material, and more particularly to a small scale functional material imbibed with a material having a functionality responsive to an externally applied field.

### BACKGROUND

Micro- and nano-composite materials continue to gain importance as optical materials. In particular, encapsulated liquid crystal substances are being developed for display applications. For example, polymer-dispersed liquid crystals (PDLC) are being converted into display uses. These materials are heterogeneous compositions that operate on the basis of a liquid crystal phase dispersed within a polymeric matrix. The size of a typical liquid crystal domain can be in the micrometer range.

Generally, the polymeric matrix and the liquid crystal phase of these systems are selected so that the refractive index of the polymer matrix matches the refractive index of the liquid crystal. However, the liquid crystals in large domains in the micrometer range for a largest dimension) of the polymer matrix, like PDLC, can cause the system to scatter visible light wavelengths. Additionally, with dielectric anisotropy the liquid crystals director can be aligned in the presence of an electric field.

The electro-optical properties of these materials can be controlled by a number of parameters that include droplet size, shape, and liquid crystal type. Furthermore, droplet size and shape are determined by composition, cure rate or solvent evaporation rate, extent of cure, solubility of the liquid crystal substance in matrix monomer, among other factors. Consequently, controlling the morphology of the liquid crystal substance in the polymer matrix can be a complex process and obtaining sub-wavelength domains that are functional has not been achieved.

### SUMMARY

Embodiments of the present disclosure include a small scale functional material, a process for the preparation of the small scale functional material, a composite material that includes the small scale functional material and a matrix material, and a tunable birefringent film formed with the small scale functional material.

For the various embodiments, the small scale functional material include a nano-domain having a cross-linked polymer domain with a largest dimension of a quarter of a wavelength of visible light or less, and a material having a functionality responsive to an externally applied field imbibed substantially throughout the cross-linked polymer domain of the nano-domain to form the small scale functional material. For the various embodiments, the material can have a functionality responsive (e.g., active) to an externally applied field. For the various embodiments, the cross-linked polymer domain can have a volume mean diameter from about 5 nanometers (nm) to about 175 nm.

For the various embodiments, the process for the preparation of a small scale functional material includes forming an emulsion of nano-domains, where each of the nano-domains has a cross-linked polymer domain with a largest dimension of a quarter of a wavelength of visible light or less, and imbibing a material having a functionality responsive to an externally applied field substantially throughout the cross-linked polymer domain of the nano-domains to form the small scale functional material. For the various embodiments, the emulsion of nano-domains can be formed in the same phase as the material having the functionality responsive to the externally applied field.

For the various embodiments, the composite material includes a matrix material and a small scale functional material dispersed in the matrix material, where the small scale functional material includes nano-domains having a cross-linked polymer domain with a volume mean diameter from about 5 nm to about 175 nm and imbibed substantially throughout the cross-linked polymer domain with an optically-active functional material responsive to an externally applied field.

For the various embodiments, the composite material can also include a matrix material and a small scale functional material dispersed in the matrix material, where the small scale functional material includes nano-domains having a cross-linked polymer domain with a volume mean diameter from about 5 nm to about 175 nm and imbibed substantially throughout the cross-linked polymer domain with an optically-active functional material responsive to an externally applied field, where the small scale functional material is dispersed spatially with varying concentration in the matrix material to create a gradient of refractive indexes in the matrix material.

For the various embodiments, the material imbibed substantially throughout the cross-linked polymer domain can be an optically-active functional material responsive to an externally applied field. The optically-active functional material can be imbibed substantially throughout the cross-linked polymer domain of the nano-domain. Examples of the optically-active functional material can be selected from the group of a liquid crystal substance, a dichroic dye, and combinations thereof. For the various embodiments, the liquid crystal substance can include a liquid crystal with a negative dielectric anisotropy.

For the various embodiments, an amount of the optically-active functional material in the nano-domain can range from about 6 percent by weight to about 60 percent by weight of the small scale functional material, based on the total weight of the nano-domain. For the various embodiments, the amount of the optically-active functional material in the nano-domain can be from about 6 percent by weight to about 30 percent by weight of the small scale functional material, based on the total weight of the nano-domain.

For the various embodiments, the amount of the optically-active functional material imbibed in the nano-domain can be dependent upon the application of the resulting small scale functional material. For example, if the application is for a phase retardation film of a liquid crystal display (LCD), the amount of the optically-active functional material used can be a function of the LCD. In addition, the amount of the optically-active functional material imbibed in the nano-domain can also be dependent upon the refractive index and/or birefringence of the optically-active functional material imbibed in the nano-domain.

As appreciated, it is also possible to use combinations of two or more of the small scale functional materials in an application, where each of the small scale functional materials can have a different type and/or amount of the optically-active functional material. In addition, it is also possible to use combinations of two or more optically-active functional materials in a small scale functional material for an application, where each of the two or more optically-active functional materials can have either the same or a different amount in the nano-domain. Either approach would allow for tuning an optical performance of a film formed with the small scale functional materials for the desired application.

For the various embodiments, the optically-active functional material can have a refractive index value that is greater than the refractive index value of the cross-linked polymer domain. For the various embodiments, the optically-active functional material can also function to prevent transmittance of at least a portion of the electromagnetic spectrum in at least one of an infrared, a visible, and an ultraviolet frequency range through the small scale functional material.

In additional embodiments, the material imbibed substantially throughout the cross-linked polymer domain responsive to the externally applied field can be selected from a group of a chemically-active functional material, the optically-active functional material, a magnetically-active functional material, an electrically-active functional material, an electro-optically-active functional material, an electro-chromic-active functional material, a thermo-chromic-active functional material, an electro-strictive functional material, a dielectric-active functional material, a thermally-active functional material, and combinations thereof.

For the various embodiments, the small scale functional material can be formed into a powder from an emulsion (e.g., through lyophilization). The small scale functional material can also be suspended in a liquid phase of either an aqueous liquid and/or a non-aqueous liquid. The suspension of the small scale functional material can be used to form a film with the small scale functional material upon removal of the liquid phase.

For the various embodiments, the matrix material can be selected from the group of a thermoplastic polymer, a thermoset polymer, a liquid phase, an ink, and a sol-gel precursor, among others. In addition, the material imbibed in the cross-linked polymer domain can maintain an essentially stable amount when dispersed in the matrix material. For the embodiments, the small scale functional material and the imbibed material (e.g., the optically-active functional material) can be discrete from the matrix material. In addition, the small scale functional material can be dispersed spatially with varying concentrations in the matrix material to create a gradient of the small scale functional material in the matrix material (e.g., a gradient of refractive indexes in the matrix material).

In some embodiments, the material can respond to an externally applied field independent of the polymeric matrix material. For example, the optically-active functional material in the small scale function material can have a state that changes when the externally applied field is applied to the matrix material. For the various embodiments, the bulk mechanical properties of the matrix material of the composite material can remain unaffected by the small scale functional material.

Embodiments of the composite material can also include configurations in which the optically-active functional material has a refractive index value that is greater than a refractive index value of the cross-linked polymer domain, and where the refractive index value of the cross-linked polymer domain is greater than a refractive index value of the matrix material.

In additional embodiments, the composite material of the present disclosure can be imbibed in a solution that can be sprayed from a nozzle (e.g., as from an Ink-Jet printer) onto a surface of a material.

### DEFINITIONS

As used herein, the term “nano-domain” refers to a particle of a cross-linked polymer domain that has a largest dimension of a quarter of a wavelength of visible light or less.

As used herein, the term “visible light” and/or the electromagnetic spectrum in a visible frequency range refers to visible electromagnetic radiation having a wavelength from about 400 nm to about 700 nm.

As used herein, the term “imbibed” refers to a process by which a material that responds to an externally applied field is absorbed into and substantially throughout the cross-linked polymer domain of the nano-domain to provide an essentially uniform amount of the material across the cross-linked polymer domain.

As used herein, the term “externally applied field” refers to an energy that is intentionally applied to the small scale functional material for the purpose of eliciting the functional response from the material imbibed in the small scale functional material.

As used herein, a “liquid crystal substance” refers to a liquid crystal compound or a mixture of liquid crystal compounds which is formed of two or more different liquid crystal compounds.

As used herein, a “liquid crystal” refers to an elongate molecule having a dipole and/or a polarizable subsistent that can point along a common axis called a director.

As used herein, the term “discrete” refers to a state in which the small scale functional material is mixed into a matrix material without the cross-linked polymer domain and/or the material dissolving and/or leaching into the matrix material.

As used herein, “negative dielectric anisotropy” includes a state in which a dielectric coefficient parallel to a director is less than a dielectric coefficient perpendicular to the director, where the director refers to a local symmetry axis around which a long range order of a liquid crystal is aligned.

As used herein, the term “dispersed” or “dispersion” refers to distributing the small scale functional material substantially throughout the matrix material in a predetermined concentration without separation at the macro level.

As used herein, the term “copolymer” refers to a polymer produced through the polymerization of two or more different monomers.

As used herein, “liquid” refers to a solution or a neat liquid (a liquid at room temperature or a solid at room temperature that melts at an elevated temperature).

As used herein, the term “volume mean diameter” refers to a volume weighted mean diameter of an assembly of cross-linked polymer domain particles: Dᵥ=Σ{vₓDₓ} where Dᵥ is the volume mean diameter, vₓ is the volume fraction of particles with diameter Dₓ. Volume mean diameter is determined by hydrodynamic chromatography as described in “Development and application of an integrated, high-speed, computerized hydrodynamic chromatograph.” Journal of Colloid and Interface Science, Volume 89, Issue 1, September 1982, Pages 94-106; Gerald R. McGowan and Martin A. Langhorst, incorporated herein by reference in its entirety.

As used herein, the term “matrix material” refers to a constituent of the composite material that includes the small scale functional material. For the composite material, the matrix material can have different physical or chemical properties as compared to the small scale functional material.

As used herein, the term “film” refers to a continuous sheet (e.g., without holes or cracks) that is from about 50 micrometers to about 1 micrometer in thickness and of a substance formed with the small scale functional material that may or may not be in contact with a substrate. The thin continuous sheet of the film may be formed from one or more layers of the substance formed with the small scale functional material, where each of the layers may be formed of the same substance formed with the small scale functional material, two or more different substances formed with the small scale functional material, or different combinations of substances formed with the small scale functional material.

As used herein, “LCD” is an abbreviation for liquid crystal display.

As used herein, “PDLC” is an abbreviation for polymer-dispersed liquid crystals.

As used herein, “PMMA” is an abbreviation for polymethyl methacrylate.

As used herein, “MMA” is an abbreviation for methyl methacrylate.

As used herein, “DPMA” is an abbreviation for dipropyleneglycol methyl ether acetate.

As used herein, “Tg” is an abbreviation for glass transition temperature.

As used herein, “UV” is an abbreviation for ultraviolet.

As used herein, “IR” is an abbreviation for infrared.

As used herein, “GRIN” is an abbreviation for gradient-index.

As used herein, “LED” is an abbreviation for a light emitting diode.

As used herein, “S” is an abbreviation for styrene.

As used herein, “EGDMA” is an abbreviation for ethylene glycol dimethacrylate.

As used herein, “DVB” is an abbreviation for divinylbenzene.

As used herein, “SDS” is an abbreviation for sodium dodecyl sulfate salt.

As used herein, “BA” is an abbreviation for butyl acrylate.

As used herein, “AMA” is an abbreviation for allyl methacrylate.

As used herein, “APS” is an abbreviation for ammonium persulfate.

As used herein, “TMEDA” is an abbreviation for N,N,N′,N′-tetramethyl-ethylenediamine.

As used herein, “MEK” is an abbreviation for methyl ethyl ketone.

As used herein, “THF” is an abbreviation for tetrahydrorfuran.

As used herein, “UPDI” is an abbreviation for ultra pure deionized.

As used herein, “PVC” is an abbreviation for polyvinyl chloride.

As used herein, “C-V” is an abbreviation for capacitance-voltage.

As used herein, “Al” is an abbreviation for the element aluminum.

As used herein, “TOL” is an abbreviation for toluene.

As used herein, “V” is an abbreviation for volt.

As used herein, “E-O” is an abbreviation for electro-optical.

As used herein, “CHO” is an abbreviation for cyclohexanone.

As used herein, “RI” is an abbreviation for refractive index.

As used herein, “APE” is an abbreviation for alkylphenol ethoxylates.

As used herein, “AE” is an abbreviation for alcohol ethoxylates.

As used herein, “wt.” is an abbreviation for weight.

As used herein “nm” is an abbreviation for nanometer.

As used herein “μm” is an abbreviation for micrometer.

As used herein “g” is an abbreviation for gram.

As used herein “° C.” is an abbreviation for degrees Celsius.

As used herein “FTIR” is an abbreviation for Fourier Transform Infrared Spectroscopy.

As used herein, “a,” “an,” “the,” “at least one,” and “one or more” are used interchangeably. The terms “comprises” and variations thereof do not have a limiting meaning where these terms appear in the description and claims. Thus, for example, a small scale functional material that comprises “a” material having a functionality responsive to an externally applied field can be interpreted to mean that the material includes “one or more” materials.

The term “and/or” means one, more than one or all of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### SUMMARY OF THE FIGURES

FIG. 1 is a graph illustrating the size distribution of nano-domains of the present disclosure.

FIGS. 2A-2C provide FTIR spectra of A) Licristal® E44 (Merck, KGaA, Darmstadt Germany); B) the nano-domains of Example 1; and C) the nano-domains of Example 1 imbibed with Licristal® E44.

FIG. 3 illustrates X-ray scattering patterns of the nano-domains of Example 1 imbibed with various liquid crystal substances.

FIG. 4 illustrates X-ray scattering patterns of the nano-domains of Example 3 imbibed with various liquid crystal substances.

FIGS. 5A and 5B illustrate an amount of liquid crystals imbibed in the nano-domains as a function of the concentration of the liquid crystal substance Licristal® E44 in the methylene chloride precursor solution for various acetone/Licristal® E44 weight ratios (FIG. 5A) and acetone to Licristal® E44 weight ratio in the precursor solution for various concentrations of Licristal® E44 in the precursor solution (FIG. 5B).

FIG. 6 illustrates the results of a least square fit model of the amounts of liquid crystal substance in dry nano-domains of the present disclosure.

FIG. 7 illustrates X-ray scattering patterns of different materials with a liquid crystal substance of the present disclosure.

FIG. 8 illustrates the amounts of Licristal® E44 imbibed in nano-domains of the present disclosure at various temperatures.

FIG. 9 illustrates the results of a least square fit model of the amount of Licristal® E44 imbibed in nano-domains of the present disclosure at various temperatures.

FIG. 10 illustrates X-ray scattering patterns of different size nano-domains of the present disclosure imbibed with Licristal® E44.

FIG. 11 illustrates X-ray scattering patterns of nano-domains of different composition according to the present disclosure imbibed with Licristal® E44.

FIG. 12 illustrates a C-V Sweep of 9.2 wt. % PMMA dissolved in CHO:TOL with no nano-domains or liquid crystal substance.

FIG. 13 illustrates a C-V Sweep of 9.2 wt. % PMMA dissolved in CHO:TOL with 6 wt. % 4-Cyano-4′-octylbiphenyl liquid crystal substance added.

FIG. 14 illustrates a C-V Sweep of 6 wt. % Licristal® E44 directly mixed into NOA-68 (optical acrylate resin, Norland).

FIG. 15 illustrates a C-V Sweep of 22 wt. % Licristal® E44 imbibed into nano-domains of the present disclosure.

FIG. 16 illustrates a C-V Sweep of 14 wt. % Licristal® E44 imbibed into nano-domains of the present disclosure.

FIG. 17 illustrates a C-V Sweep of 22 wt. % Licristal® E44 imbibed into nano-domains of the present disclosure and mixed 1:1 with PMMA.

FIG. 18 illustrates a C-V Sweep of 7 wt. % Licristal® E44 imbibed into nano-domains of the present disclosure.

FIG. 19 illustrates a C-V Sweep of 7 wt. % Licristal® E44 imbibed into nano-domains of the present disclosure.

FIG. 20 illustrates a measured E-O coefficient (pm/V) versus effective Licristal® E44 wt. %.

### DETAILED DESCRIPTION

Embodiments of the present disclosure include a small scale functional material that includes a nano-domain having a cross-linked polymer domain with a largest dimension of a quarter of a wavelength of visible light or less, and a material having a functionality responsive to an externally applied field imbibed substantially throughout the cross-linked polymer domain to form the small scale functional material.

Embodiments of the present disclosure allow for the small scale functional material to be dispersed into a matrix material to form a composite material. In addition, embodiments of the present disclosure allow for the small scale functional material to form a film of one or more layers. In addition, more than one film can be used for an application. For the various embodiments, the small scale functional material can have utility in numerous applications in the optical, aesthetic, electrical, mechanical and/or chemical arts, among others. Other applications for using the small scale functional material alone, with additional components, and/or in the composite material are also possible.

According to the various embodiments, the small scale functional material is assembled from a nano-domain of across-linked polymer and functionalized with a material that is responsive to an externally applied field: For the various embodiments, the cross-linked polymer of the nano-domain has a cross-linked polymer domain with a largest dimension of a quarter of a wavelength of visible light or less. These values can include, but are not limited to, a particle size distribution in which the volume mean diameter of the nano-domain is from about 5 nm to about 175 nm. For the various embodiments, the nano-domain can have a volume mean diameter from about 10 nm to about 100 nm.

Embodiments of the present disclosure also provide a method for forming the nano-domain. For example, the nano-domain can be formed through an emulsion process in which each of the nano-domains has a largest dimension as discussed herein (e.g., a quarter of a wavelength of visible light or less) (see, e.g., Kalantar et al., U.S. Publication Nos. 2004/0054111 and 2004/0253442, which are both incorporated herein by reference in their entirety).

For the various embodiments, the emulsion process includes emulsifying a monomer mixture and a surfactant in an aqueous phase. For the various embodiments, the emulsion is a microemulsion of stabilized nano-domains in the aqueous phase. Suitable examples of surfactants include, but are not limited to, polyoxyethylenated alkylphenols (alkylphenol “ethoxylates” or APE); polyoxyethylenated straight-chain alcohols (alcohol “ethoxylates” or AE); polyoxyethylenated secondary alcohols, polyoxyethylenated polyoxypropylene glycols; polyoxyethylenated mercaptans; long-chain carboxylic acid esters; glyceryl and polyglyceryl esters of natural fatty acids; propylene glycol, sorbitol, and polyoxyethylenated sorbitol esters; polyoxyethylene glycol esters and polyoxyethylenated fatty acids; alkanolamine condensates; alkanolamides; alkyl diethanolamines; 1:1 alkanolamine-fatty acid condensates; 2:1 alkanolamine-fatty acid condensates; tertiary acetylenic glycols; polyoxyethylenated silicones; n-alkylpyrrolidones; polyoxyethylenated 1,2-alkanediols and 1,2-arylalkanediols; alkyl polyethoxylates, alkyl aryl polyethoxylates, alkylpolyglycosides, and combinations thereof. Use of ionic surfactants is also possible.

Examples of commercially available surfactants include Tergitol™ and Triton™ surfactants, both from The Dow Chemical Company. The amount of surfactant used must be sufficient to at least substantially stabilize the formed nano-domains in the water or other aqueous polymerization medium. This precise amount will vary depending upon the surfactant selected as well as the identity of the other components. The amount will also vary depending upon whether the reaction is run as a batch reaction, a semi-batch reaction, or as a continuous reaction. Batch reactions will generally require the highest amount of surfactant. In semi-batch and continuous reactions, surfactant will become available again as the surface to volume ratio decreases as particles grow, thus, less surfactant may be required to make the same amount of particles of a given size as in a batch reaction. The surfactant:monomer weight ratios of from 3:1 to 1:20, and from 2.5:1 to 1:15, are useful. The useful range may in fact be broader than this.

The aqueous liquid component may be water, a combination of water with hydrophilic solvents, or a hydrophilic solvent. The amount of aqueous liquid used can be at least 40 percent by weight based on the total weight of the reaction mixture. For the various embodiments, the amount of aqueous liquid used can be at least 50 percent by weight based on the total weight of the reaction mixture. For the various embodiments, the amount of aqueous liquid used can be at least 60 percent by weight based on the total weight of the reaction mixture. The amount of aqueous liquid used can also be no greater than 99 percent by weight, no greater than 95 percent by weight, no greater than 90 percent by weight, and/or no greater than 85 percent by weight.

The initiator may be a free radical initiator. Examples of suitable free radical initiators include 2,2′-azobis (2-amidinopropane) dihydrochloride, for example, and redox initiators, such as H₂O₂/ascorbic acid or tert-butyl hydroperoxide/ascorbic acid, or oil soluble initiators such as di-t-butyl peroxide, t-butyl peroxybenzoate or 2,2′-azoisobutyronitrile, or combinations thereof. The amount of initiator added can range from 0.01 to 5.0, from 0.02 to 3.0, or from 0.05 to 2.5 parts by weight per 100 parts by weight of monomer. Other initiators are also possible. In addition to the use of free radical initiators, other mechanisms for polymerization include, but are not limited to, curing with ultraviolet light.

The monomer used in forming the nano-domain can be one or more monomers capable of undergoing free radical polymerization. Suitable monomers include those containing at least one unsaturated carbon to carbon bond and/or more than one carbon to carbon double bond. A single type of monomer may be used or two or more different types of monomers may be used in forming the nano-domain.

Examples of suitable monomers can be selected from the group of styrenes (such as styrene, alkyl substituted styrenes, aryl-alkyl substituted styrenes, alkynylaryl alkyl substituted styrenes, and the like); acrylates and methacrylates (such as alkyl acrylates or alkyl methacrylates and the like); vinyls (e.g., vinyl acetate, alkyl vinyl ether and the like); allyl compounds (e.g., allyl acrylate); alkenes, alkadienes (e.g., butadiene, isoprene); divinylbenzene or 1,3-diisopropenylbenzene; alkylene glycol diacrylates and combinations (e.g., mixtures for producing copolymers) thereof. As used herein, the term “alkyl” can include a saturated linear or branched monovalent hydrocarbon group having from 4 to 14 carbons (C4-C14). As used herein, the term “alkenes” can include an unsaturated hydrocarbon having at least one carbon-carbon double bond having from 4 to 14 carbons (C4-C14)

For the various embodiments, the nano-domain can be formed from monomers of methyl methacrylate (MMA) and butyl acrylate. For the various embodiments, the nano-domain can be formed from MMA, butyl acrylate, and styrene monomers. Other copolymer configurations for the nano-domain are also possible.

In addition, monomers of liquid crystal polymers can be used in forming the nano-domain of the present disclosure. Such monomers can include partially crystalline aromatic polyesters based on p-hydroxybenzoic acid and related monomers. Specific examples of monomers that can be polymerized to form nano-domain with co-polymerized liquid crystalline functionality include 2-propenoic acid, 4′-cyano[1,1′-biphenyl]-4-yl ester; cholest-5-en-3-ol (3β), 2-propenoate; benzoic acid, 4-[[[4-[(1-oxo-2-propenyl)oxy]butoxy]carbonyl]oxy], 2-methyl-1,4-phenylene ester; benzoic acid, 3,4,5-tris[[11]-[(1-oxo-2-propen-1-yl)oxy]undecyl]oxy], sodium salt (1:1); phenol, 4-[2-(2-propen-1-yloxy)ethoxy]; [1,1′-biphenyl]-4-carbonitrile, 4′-(4-penten-1-yloxy); phenol, 4-(10-undecenyloxy); benzoic acid, 4-[2-(2-propenyloxy)ethoxy]; 1,4-cyclohexanedicarboxylic acid, bis[4-(10-undecenyloxy)phenyl]ester, trans; benzoic acid, 4-[[6-[(1-oxo-2-propenyl)oxy]hexyl]oxy]-, 2-chloro-1,4-phenylene ester; and benzoic acid, 4-[[6-[(1-oxo-2-propenyl)oxy]hexyl]oxy]-, 2-chloro-1,4-phenylene ester, homopolymer.

According to various embodiments, the nano-domain is cross linked through the use of ultraviolet light or a radical initiated cross-link process. Cross linking of the nano-domain can occur either before and/or after imbibing of the material. In such embodiments at least some of the monomers will have more than one unsaturated carbon to carbon bond. Using a styrene monomer with divinylbenzene or 1,3-diisopropenylbenzene is a useful embodiment. An amount of crosslinking monomer (e.g., the monomer having more than one carbon to carbon double bond available for reaction) used can be less than about 100, less than about 70, less than about 50 percent by weight based on the total weight of monomers and greater than about 1, or greater than about 5 percent by weight. The total amount of monomers added to the composition is in the range from about 1 to about 65, from about 3 to about 45, or from about 5 to about 35 percent by weight based on total weight of the composition.

Optionally, a hydrophobic solvent may be added to the monomer, where non-limiting examples of such solvents include toluene, ethylbenzene, mesitylene, cyclohexane, hexane, xylene, octane and the like, and combinations thereof. If used, the amount of hydrophobic solvent may be from about 1 to about 95 percent, from about 2 to about 70 percent, or from about 5 to about 50 percent by weight of a hydrophobic liquid. Total amount of hydrophobic liquid can be from about 1 to about 60 percent, from about 3 to about 45 percent, or from about 5 to about 35 percent by weight of the total mixture.

The processes used to make the nano-domains of the present disclosure may be run as a batch process, as a multi-batch process, as a semi-batch process, or as a continuous process, as discussed in Kalantar et al., U.S. Publication Nos. 2004/0054111 and 2004/0253442. Suitable reaction temperatures can be in the range of about 25° C. to about 120° C.

Once formed, the nano-domains may be precipitated by mixing the emulsion with an organic solvent or solvent mixture that is at least partially soluble in water, and in which resulting aqueous liquid-solvent mixture, the formed polymer is substantially insoluble. Examples of such solvents include, but are not limited to, acetone, methyl ethyl ketone, and methanol. This step precipitates the nano-domains, which can be used dry or be redispersed in a suitable organic solvent such as gamma butyrolactone, tetrahydrofuran, cyclohexanone, mesitylene, or dipropyleneglycol methyl ether acetate (DPMA) for subsequent use. Precipitation is also useful in removing a substantial amount of the surfactant residue from the nano-domains.

The nano-domains may also be purified by a variety of methods as are known in the art such as passing through a bed of ion exchange resin prior to precipitation; precipitating and washing thoroughly with deionized water and optionally with a solvent in which the nano-domains are insoluble; and precipitating, dispersing the nano-domains in an organic solvent and passing the dispersion through a silica gel or alumina column in that solvent.

After precipitation, a spray drying step may be used to form a powder of the nano-domains, where the drying temperature is not high enough to cause residual reactive groups on the nano-domains to react and cause agglomeration and an increase in nano-domains particle size. Lyophilization may also be used to form the powder of the nano-domains.

Other methods for forming the nano-domains for the present disclosure are also possible. Examples include those described by Mecerreyes, et al. Adv. Mater. 2001, 13, 204; Funke, W. British Polymer J. 1989, 21, 107; Antonietti, et al. Macromolecules 1995, 28, 4227; and Gallagher, et al. PMSE. 2002, 87, 442; and Gan, et al. Langmuir 2001, 17, 4519.

For the various embodiments, the nano-domain can be functionalized by imbibing a material having a functionality responsive to an externally applied field substantially throughout the cross-linked polymer domain to form the small scale functional material. The functionality imparted to the small scale functional material by the material can include, but is not limited to, electrical, optical, magnetic, chemical, electro-optical, electro-chromic, magneto-optical, thermochromic, dielectric, and/or thermal properties. For the various embodiments, imbibing the material having a functional response into the cross-linked polymer domain of the nano-domains can occur either after and/or during the formation of the cross-linked polymer domain.

As discussed herein, the cross-linked polymer can be functionalized to be responsive to one or more of a variety of externally applied fields. Examples of such externally applied fields include, but are not limited to, an electrical field, a magnetic field, an electromagnetic field, a thermal gradient, a chemical gradient, and/or mechanical forces, such as mechanical pressures.

For the various embodiments, the cross-linked polymer domain has a structure that provides a contiguous substantially uniform network that extends through the cross-sectional dimensions of the nano-domain (e.g., it is a solid particle having a tortuous porous network). For the various embodiments, the porosity of the structure allows the material that provides the functional response to be imbibed into the nano-domain structure. In other words, the cross-linked polymer domain can act like a sponge to imbibe and retain the material. This structure is in contrast to a shell, for example, that holds a volume of the material.

For the various embodiments, the imbibed material can disperse uniformly substantially throughout the cross-linked polymer domain of the nano-domain. This allows for an essentially uniform concentration of the material through the nano-domain regardless of the location within and/or across the cross-linked polymer domain. In addition, the porosity of the nano-domain is such that the material can also maintain an essentially stable concentration in the cross-linked polymer domain when dispersed in the matrix material. As discussed herein, the matrix material can include an inorganic and/or an organic polymer matrix material. Other matrix materials are also possible.

A variety of materials can be used to functionalize the nano-domain of the small scale functional material. For example, suitable materials having a functionality responsive to an externally applied field can be selected from a group of a chemically-active functional material, an optically-active functional material, a magnetically-active functional material, an electrically-active functional material, an electro-optically-active functional material, an electro-chromic-active functional material, a thermo-chromic-active functional material, an electro-strictive functional material, a dielectric-active functional material, a thermally-active functional material, and combinations thereof.

For example, suitable materials can include optically-active functional materials responsive to an externally applied field including those selected from the group of a liquid crystal substance, a dichroic dye, and combinations thereof. The amount of the optically-active functional material imbibed into the nano-domain can range from about 6 percent by weight to about 60 percent by weight of the small scale functional material. In addition, the optically-active functional material can have a refractive index value that is greater than the refractive index value of the cross-linked polymer domain.

For the various embodiments, the amount of the optically-active functional material imbibed in the nano-domain can be dependent upon the application of the resulting small scale functional material. So, for example, if the application is for a phase retardation film of a liquid crystal display (LCD), the amount of the optically-active functional material used will be a function of the desired LCD. In addition, the amount of the optically-active functional material imbibed in the nano-domain can also be dependent upon the anisotropy, the refractive index, and/or the birefringence of the optically-active functional material imbibed in the nano-domain.

As appreciated, it is also possible to use combinations of two or more of the small scale functional materials in an application, where the small scale functional materials can have different types and/or amounts of the optically-active functional material. For example, it would be possible to have a film with a first layer of the small scale functional material that contains a first nano-domain functionalized with a first material at a first predetermined amount and a second layer of the small scale functional material that contains a second nano-domain functionalized with a second material at a second predetermined amount. Using this approach, or others, it would be possible to “tune” a resulting multi-layer film for a desired application, where two or more layers having the small scale functional material could be used to accomplish this goal.

Examples of liquid crystal substances suitable for imbibing into the nano-domain of the small scale functional material include those in a isotropic phase, a nematic phase, a twisted nematic phase, a smectic phase, a chiral nematic phase, and/or a discotic phase. For the various embodiments, suitable liquid crystal substances can include, but are not limited to, 4-Pentylphenyl 4-pentylbenzoate; 4-Pentylphenyl 4-methoxybenzoate; 4-Pentylphenyl 4-methylbenzoate; 4-Pentylphenyl 4-octyloxybenzoate; 4-Pentylphenyl 4-propylbenzoate; 2,5-Dimethyl-3-hexyne-2,5-diol; 6-[4-(4-Cyanophenyl)phenoxy]hexyl methacrylate; Poly(4-hydroxy benzoic acid-co-ethylene terephthalate); p-Acetoxybenzylidene p-Butylaniline; p-Azoxyanisole; 4,4′-Azoxydiphenetole; Bis(p-Butoxybenzylidene) a,a′-Bi-p-toluidine; Bis(p-heptyloxybenzylidene) p-Phenylenediamine; Bis(p-octyloxybenzylidene) 2-Chloro-1,4-phenylenediamine; p-Butoxybenzoic Acid; p-Butoxybenzylidene p-Butylaniline; p-Butoxybenzylidene p-Ethylaniline; p-Butoxybenzylidene p-Heptylaniline; p-Butoxybenzylidene p-octylaniline; p-Butoxybenzylidene p-Pentylaniline; p-Butoxybenzylidene p-Propylaniline; Butyl p-Hexyloxybenzylidene p-Aminobenzoate; Cholesteryl Benzoate; Cholesteryl Decanoate (Caprate); Cholesteryl dodecanoate (Laurate); Cholesteryl Elaidate; Cholesteryl Erucate; Cholesteryl Ethyl Carbonate; Cholesteryl Heptanoate (Enanthate); Cholesteryl Hexadecyl Carbonate; Cholesteryl Methyl Carbonate; Cholesteryl Octanoate (Caprylate); Cholesteryl Oleyl Carbonate; Cholesteryl Pentanoate (Valerate); Cholesteryl Tetradecanoate (Myristate); p-Cyanobenzylidene p-Nonyloxyaniline; 4-Cyano-4′-butylbiphenyl; 4-Cyano-4′-hexylbiphenyl; 4-Cyano-4′-octylbiphenyl; 4-Cyano-4′-pentylbiphenyl; 4-Cyano-4′-pentyloxybiphenyl; p-Decyloxybenzoic Acid; p-Decyloxybenzylidene p-Butylaniline; p-Decyloxybenzylidene p-Toluidine; Dibenzylidene 4,4′-Biphenylenediamine; 4,4′-Diheptylazoxybenzene; 4,4′-Diheptyloxyazoxybenzene; 4,4′-Dihexylazoxybenzene; 4,4′-Dihexyloxyazoxybenzene; 4,4′-Dihexyloxyazoxybenzene; 4,4′-Dinonylazoxybenzene; 4,4′-Dioctylazoxybenzene; 4,4′-Dipentylazoxybenzene; p-Dodecyloxybenzoic Acid; p-Ethoxybenzylidene p-Butylaniline; p-Ethoxybenzylidene p-Cyanoaniline; p-Ethoxybenzylidene p-Heptylaniline; Ethyl 4-(4-pentyloxybenzylideneamino)benzoate; p-Heptyloxybenzylidene p-Butylaniline; 4-Heptyloxybenzylidene 4-heptylaniline; p-Hexadecyloxybenzoic Acid; p-Hexyloxybenzalazine; p-Hexyloxybenzoic Acid; 4-(4-Hexyloxybenzoyloxy)benzoic acid; p-Hexyloxybenzylidene p-Aminobenzonitrile; p-Hexyloxybenzylidene p-Butylaniline; p-Hexyloxybenzylidene p-Octylaniline; p-Methoxybenzylidene p-Biphenylamine; p-Methoxybenzylidene p-Butylaniline; p-Methoxybenzylidene p-Cyanoaniline; p-Methoxybenzylidene p-Decylaniline; p-Methoxybenzylidene p-Ethylaniline; p-Methoxybenzylidene p-Phenylazoaniline; 4-Methoxyphenyl 4′-(3-Butenyloxy)benzoate; p-Methylbenzylidene p-Butylaniline; p-Nitrophenyl p-Decyloxybenzoate; p-Nonyloxybenzoic Acid; p-Nonyloxybenzylidene p-Butylaniline; p-Octyloxybenzoic Acid; p-Octyloxybenzylidene p-Cyanoaniline; p-Pentylbenzoic Acid; p-Pentyloxybenzoic Acid; p-Pentyloxybenzylidene p-Heptylaniline; 4-Pentylphenyl 4′-propylbenzoate; p-Propoxybenzoic Acid; Terephthalylidene Bis(p-butylaniline); Terephthalylidene Bis(p-nonylaniline); p-Undecyloxybenzoic Acid and/or 4-pentyl-4′-cyano biphenyl. Commercially available liquid crystal substances include, but are not limited to, those from Merck (KGaA, Darmstadt Germany) under the trade designator Licristal® E44 (E44); Licristal® E7 (E7); Licristal® E63 (E63); Licristal® BL006 (BL006); Licristal® BL048 (BL048); Licristal® ZLI-4853 (ZLI-4853) and Licristal® MLC-6041 (MLC-6041). Other commercially available liquid crystal substances are also possible.

For the various embodiments, useful liquid crystal substances can also include those with a negative dielectric anisotropy. As used herein, “negative dielectric anisotropy” includes a state in which a dielectric coefficient parallel to a director is less than a dielectric coefficient perpendicular to the director, where the director refers to a local symmetry axis around which a long range order of the liquid crystal in the substance is aligned. Examples of liquid crystal substances having a negative dielectric anisotropy can include, but are not limited to, those found in U.S. Pat. No. 4,173,545 (e.g., p-alkyl-phenol-4′-hydroxybenzoate-4-alkyl(alkoxy)-3-nitrobenzoate), those having positive or negative dielectric anisotropies or that can switch from positive to negative as in the case of 4-cyano-4′-hexylbiphenyl and salicylaldimine (see: Physica B: Condensed Matter, Vol. 393, (1-2), pp 270-274), those discussed in “Advanced Liquid Crystal Materials with Negative Dielectric Anisotropy for Monitor and TV Applications” by Klasen-Memmer et al. (Proc Int Disp Workshops, vol. 9, pages 93-95, 2002), those found in “Nematic materials with negative dielectric anisotropy for display applications” by Hird et al. (Proc. SPIE Vol. 3955, p. 15-23, Liquid Crystal Materials, Devices, and Flat Panel Displays, March 2000), and those found in “Stable Liquid Crystals with Large Negative Dielectric Anisotropy” by Osman et al., (Helvetica Chimica Acta, Vol. 66, Issue 6, pp 1786-1789). The optically-active functional material can also function to prevent transmittance of at least a portion of radiant energy (e.g., light) in at least one of an infrared, a visible, and an ultraviolet frequency range through the small scale functional material.

As discussed above in the background, controlling the morphology of a liquid crystal substance in a polymer matrix can be a complex process and obtaining sub-wavelength domains that are functional has not yet, until the present disclosure, been achieved. One theory as to why this was not possible until now is that the liquid crystal molecules have a tendency to self-organize into large structures. These large structures can be negatively influenced by frictional forces imposed by the walls of the domains in which they are contained as the large structures try to rotate under an externally applied field. In other words, because the self-organized liquid crystal molecules are so large relative a volume of the domain, where the ratio of volume to surface area for the domains is surface area dominated, there are significant and detrimental frictional forces imposed on the self-organized liquid crystal molecules.

Surprisingly, however, the embodiments of the present disclosure do not encounter these issues. Rather, self-organization of the liquid crystal substance imbibed substantially throughout the nano-domain of the small scale functional material is believed to be minimized. A possible reason for this is that the structure of the cross-linked polymer domain helps to minimize the ability of the liquid crystal substance to organize to the extent that it becomes too associated with itself (e.g., so that it does not become too large). As a result, the frictional forces encountered by the liquid crystal substance in the cross-linked polymer domain can be minimized as compared to other domain structures.

Besides liquid crystal substances, other possible materials for imbibing into the nano-domain of the small scale functional material can include those having electro-responsive and/or magneto-responsive properties. These can include those materials that can be used to affect the conductive/insulative properties of the small scale functional material impacting electrical and/or thermal conduction. In addition, materials affecting a dielectric constant of the small scale functional material can be used to increase or decrease the dielectric constant of the nano-domain material. For example, the dielectric constant of the nano-domain can be increased by having a high dielectric material such as barium strontium titanate, barium titanate, copper phthalocyanine oligomer (o-CuPc) nanoparticles (see: Appl. Phys. Lett. 87, 182901 (2005)), silver nanoparticles, aluminum oxyhydroxide AlO[OH]ₙ, salts such as LiN(C₂F₅SO₂)₂ or LiClO₄, Al₂O₃, ZnO, SnO, and other nano metal oxide fillers of various oxidation states, or in some cases a metal such as gold, silver, copper or alloys of these metals.

Ferroelectric and/or ferromagnetic materials could also be added to the nano-domain to improve the properties of the nano-domain and/or the material. Examples of such materials can be organometallic compounds in which there is a bonding interaction between one or more carbon atoms of an organic group and a main group, transition, lanthanide, or actinide metal atom(s). In addition, other organic molecules can be imbibed into the nano-domain structure.

For the various embodiments, the functional properties of the imbibed material are not significantly affected once imbibed in the nano-domain structure. In addition, the nano-domain can also induce order to the material imbibed substantially throughout the nano-domain. Ordered structure of similar characteristic length for the material and the nano-domain can be determined by x-ray scattering results, as provided in the Examples Section, below. These results suggest that an order can be induced by the cross-linked polymer domain. For example, when liquid crystal substances are imbibed substantially throughout the cross-linked polymer domain of the nano-domain, scattering studies discussed herein indicate a liquid crystal ordered structure with a characteristic length of about 4 nm. This order induced by the nano-domain is not observed in neat liquid crystal substances or in a solution of liquid crystal substances in polymethyl methacrylate. In addition, the electro-optical activity of the liquid crystal remain when the liquid crystal substance is imbibed substantially throughout the cross-linked polymer domain of the nano-domain.

In additional embodiments, a crosslink density of the cross-linked polymer domain of the small scale functional material can be increased after imbibing the material into the cross-linked polymer domain of the nano-domain. For various embodiments, the post-imbibing cross-linking can be used to form non-spherical nano-domains (e.g., ellipsoids). In addition, the material can also be cross-linked to the polymer domain of the nano-domain once imbibed. Once formed the small scale functional materials can be prepared as a powder (e.g., lyophilized) for storage and subsequent use as discussed herein.

For the various embodiments, the small scale functional material can be blended with a matrix material, where the small scale functional material and the matrix material remain discrete. In addition, the small scale functional material can be incorporated into the matrix material in a concentration that does not affect the bulk mechanical properties of the matrix material. So, the material can respond to the externally applied field independent of the polymeric matrix material.

For the various embodiments, the small scale functional material used to modify the matrix material may do so without causing haze or other issues that pertain to the clarity of the matrix material as compared to the unmodified matrix material. As discussed, one reason for this may be that the nano-domain of the small scale functional material has a largest dimension of a quarter of a wavelength of visible light or less. By controlling the size of the nano-domain, the transparency of the matrix material can be maintained for, by way of example, optical applications by eliminating domains of the size able to scatter light. The small scale functional material can also be useful in dispersing functional material that would not otherwise be dispersible in a matrix material.

For the various embodiments, the matrix material into which the small scale functional material is incorporated can include an organic and/or an inorganic polymer. These polymers can include thermoplastic polymers. For the various embodiments, the small scale functional material can be dispersed into a thermoset resin prior to cross-linking the thermoset resin. Alternatively, the small scale functional material can be suspended in an ink solution and/or liquid media, such as an organic and/or inorganic media, to improve the brightness or otherwise modify the refractive index of the solution. The small scale functional material can also be mixed with sol-gel pre-cursor solutions (e.g., tetraethyl orthosilicate). In addition, the small scale functional material could be mixed with other solid materials to form a solid mixture.

Other additives can also be dispersed into the matrix material, including more than one of the small scale functional materials, where each material can have a different functionality. In addition to different functionality, the small scale functional materials can have a variety of amounts, including identical amounts or different amounts. The amount chosen may depend upon the desired response from the resulting material having the small scale functional materials.

One advantage to using the nano-domain is that the material having the functional response remains discrete at length scales less than the quarter wavelength of light so as to preserve the aesthetic nature of the matrix material. By being discrete (rather than solubilized) the material can act in its preferred manner. For example, as discussed herein the state of an optically-active functional material (e.g., a liquid crystal substance) in the small scale functional material dispersed in a matrix material can be changed by an externally applied field applied to the composite material so as to control the bulk electro-optical properties of the composite material. This can be done while maintaining optical clarity of the matrix material.

Additionally, by keeping the material discrete, the continuous properties of the matrix materials can be better preserved, for example, preserving the rheological and mechanical properties of the matrix material. Other properties of the matrix material that can be preserved and/or enhanced include gas diffusion barrier, optical, and electrical/magnetic (dielectric) properties. The ability to process these active dispersions by polymer processing methods such as extrusion, injection molding, spray-coating, and/or Ink-Jet printing allow them to be used in many applications that may be prohibitive as a homogeneous material.

For the various embodiments, the dispersion of the small scale functional material in the matrix material can be uniform. In alternative embodiments, the dispersion of the small scale functional material can result in a concentration gradient extending through and/or across the matrix material. For example, the small scale functional material can be dispersed spatially with varying concentration in the matrix material to create a gradient of refractive indexes in the matrix material. For the various embodiments, the concentration gradients can be extended through a thickness of the matrix material and/or across a width or length of the matrix material.

For the various embodiments, the selection of the cross-linked polymer domain can be made based, in part, on the polymeric matrix material(s) into which the small scale functional materials are incorporated. For example, the cross-linked polymer domain can be selected so as to allow the small scale functional material to be dispersed within the polymeric matrix material (e.g., a polymer melt). Approaches to dispersing the small scale functional material substantially throughout the matrix material can be carried out in conventional polymer processing equipment such as a single screw extruder, a twin screw extruder, a two roll mill, and/or a mixer, such as a Henschel type of mixer, Haake type of mixer, and the like.

Embodiments of the present disclosure can be useful in a variety of applications. Such applications can include, but are not limited to, optical applications such as displays, ophthalmic lenses, fiber optics, Bragg reflectors, and wave guides, among others. The nano-domain of the small scale functional material can be made more rigid or less rigid by the selection of monomers used to form the nano-domain (e.g., T_{g} of the cross-linked polymer domain) and/or cross-linking density of the cross-linked polymer domain. For the various embodiments, it may also be possible to adjust the T_{g} of the cross-linked polymer domain in an attempt to modify (e.g., decrease) the mobility of the liquid crystal substance and the cross-linked polymer domain. The matrix material can be selected to meet the processing and integrity requirements of the application for the composite material. Additionally, the small scale functional materials can be dispersed in a concentration gradient spatially using a variety of mixing, extrusion, and/or printing technologies to create optical materials such as gradient refractive index lenses, anti-reflective films, or, for example, films that control viewing angle.

Materials having a functionality responsive to an externally applied field can also be imbibed into the nano-domain of the small scale functional material that will result in a change in the refractive index of both the nano-domain of the small scale functional material and/or the matrix material. This would allow the refractive index to be “tunable” through the composition of the small scale functional material and/or the imbibed material. The refractive index can be modified either to be lower or higher than the matrix material or the nano-domain of the small scale functional material. The principle advantage of the refractive index modifiers is that the refractive index of the matrix material or the nano-domain of the small scale functional material can be modified while remaining optically transparent to the eye of the viewer. One way to achieve materials having a higher or a lower refractive index is to have the small scale functional material with an imbibed material with a higher or a lower refractive index than the nano-domain of the small scale functional material and/or the matrix material.

A switchable refractive index (e.g., through the use of an electric field) can also be achieved by imbibing a suitable liquid crystal substance into the nano-domain of the small scale functional material. For example, ferroelectric liquid crystals, also known as chiral nematic or smectic-cholesteric liquid crystals, can be imbibed into the nano-domain of the small scale functional material. An advantage of ferroelectric liquid crystals is they can be used to create bi-stable changes (and therefore do not require a sustaining voltage) in refractive index after the application of an externally applied field (e.g., they are switchable).

A tunable birefringent film formed with the small scale functional materials of the present disclosure would also be useful for a wide variety of optical applications. Examples of such optical applications include, but are not limited to, optical switching, waveguide multiplexing, beam steering, dynamic focusing, displays, smart windows, eyewear, and industrial optical systems.

For the various embodiments, a tunable birefringent film could be formed with the small scale functional material placed between at least two electrodes. Examples of electrodes could include those formed with conductive materials such as poly(3,4-ethylenedioxythiophene, indium tin oxide (ITO), and/or ITO coated substrates. Other types and forms of electrodes are possible. The electrodes would be coupled to a driver used to apply a current across the tunable birefringent film. The applied current could operate to change the birefringence of the tunable birefringent film as a function of the applied current. For the various embodiments, two or more of the tunable birefringent films could be used together in an optical application.

One specific application for the tunable birefringent film of the present disclosure can be within a LCD. In this application, the tunable birefringent film can be used to form a dynamic privacy film for the LCD. The dynamic privacy film could allow for a phase retardation compensation value of the tunable birefringent film to be “tuned” as a function of an externally applied field, which would change a contrast ratio of the LCD as a function of viewing angle. This would allow the ability to dynamically control the viewing angle of the LCD.

The ability to dynamically control the viewing angle would be attractive to many LCD users who wish to vary the privacy inherent to their viewing. The tunable birefringent film of the present disclosure would allow, for example, a switch on a personal laptop, mobile phone or automatic teller machine (ATM) that enables privacy viewing. This switch would control the tunable birefringence film to alter the phase retardation compensation output from the liquid crystal cell and allow the user to better protect the information being reviewed in, for example, an airplane or other public place.

The tunable birefringent film of the present disclosure can include an index ellipsoid that can be varied with an applied electric field. One way to achieve this is to use the small scale functional material of the present disclosure to coat directly from solution or added to another polymer matrix. During coating or film forming, uniaxial tension or shear can be applied to prolate the small scale functional material thereby pre-aligning the liquid crystal substance. As an electric field is placed across the thickness of the film the liquid crystal substance will rotate and align in the electric field.

A dichroic dye can also be imbibed in addition to one or more of the liquid crystal substances. Alternatively, a dichroic dye can be imbibed by itself and/or with one or more of the other functional materials discussed herein. Substances having discotic liquid crystals, both columnar and the nematic, can also be imbibed. Examples of suitable dichroic dyes and/or additional liquid crystal substances include those found in U.S. Pat. Nos. 4,401,369 and 5,389,285; WO 1982/002209; arylazopyrimidines; Benzo-2,1,3-thiadiazoles (see: J. Mater. Chem., 2004, 14, 1901-1904); Merck Licristal®, and Merck Licrilite®, among others.

A variety of additional materials can be imbibed into the nano-domain to affect the appearance of the small scale functional material and/or the matrix material. For example, by selecting the refractive index of the nano-domain material appropriately (e.g., the refractive index of the functional material being greater than the refractive index of the nano-domain material, which is greater than the refractive index of the matrix material) the matrix material and/or the material can appear brighter due to a Fresnel effect on total internal reflectance.

In addition, dyes or pigments can be added to the nano-domain to provide reflective colors. Also, a variety of other compounds that absorb light at a particular frequency can be imbibed and used to color the nano-domain by subtractive coloring. Additionally, nanosized metal particles in the nano-domain can give off color via plasmon scattering. The resulting color can be a function of the metal type, concentration, and/or size of particle.

In additional embodiments, the translucency of the nano-domain can also be tuned. For example, tuning the translucence of the nano-domain can occur by adjusting the size and refractive index of the cross-linked polymer domain. Absorption and/or reflection of specific wavelengths (e.g., UV, IR), similar to subtractive coloring, using imbibed materials are also possible. For example, using ZnO as the material can absorb UV light. Additionally, the cross-linked polymer domain can also be selected to help in reflecting specific frequencies of light.

The articles discussed herein, and others, can be formed from the processing techniques discussed herein. Example include, but are not limited to, thermo-processing dispersions of the small scale functional material and the polymer matrix material in injection molding, blow molding, film extrusion, sheet extrusion, co-extrusion, compression molding, roto-molding, thermoforming, and/or vacuum molding processes. Alternatively, articles can be formed from dispersions of the small scale functional material and the matrix material through foaming process and/or coating processes. Coating processes can include, but are not limited to, draw coating, doctor-blade coating, spin-coating, painting, electrostatic painting, Ink-Jet printing, screen printing, gravure printing, curtain coating, and/or spray coating, among others.

The small scale functional material and/or the composite material of the present disclosure can be used in a variety of applications. For example, the small scale functional material that change refractive index under an externally applied field can be used in dynamic birefringent films, polarizer technologies, and multi-layer displays. They could also be used as a more traditional polymer-dispersed liquid crystal if the nano-domains were enlarged to cause the scattering of light. Additionally, a variety of electroluminescent functional materials could be used to make an electroluminescent film or ink for use in a display.

The small scale functional material of the present disclosure could also be added to multi-layer films to create a layer that filters infrared and/or ultraviolet light as a function of an externally applied field. Low emissive coatings are also possible, where the nano-domains can include fluorine doped tin oxide or other materials that exhibit a reflectance and/or absorbance due to surface plasmon resonance effects in the near-infrared spectrum.

In additional applications, the small scale functional materials of the present disclosure having a high refractive index can be added to fiber optic cables to provide either a grading of refractive index from a center to an edge (e.g., low-to-high), or can be used in cladding the outside of the optical fiber to increase internal reflection of the light wave traveling down the fiber. Alternatively, small scale functional materials with higher or lower refractive indexes than a matrix material can be spatially distributed in a grid pattern using method such as Ink-Jet printing or microstamping to create a Bragg reflector. Further the small scale functional materials could be filled with a material whose refractive index changes with an externally applied field (e.g., an applied electrical field) such that the Bragg reflector can be turned on and off. Additionally, because of the ability to print the small scale functional material in three dimensions, a holographic Bragg reflector may also be possible.

The small scale functional material of the present disclosure can also be useful in the area of ophthalmic lenses. For example, a small scale functional material having a high refractive index could be mixed and dispersed into ophthalmic lens material (e.g., polymethylmethacrylate, polycarbonate, polyurethane) to increase the refractive index of the lens, allowing for more flexibility and control in lens design. In addition, a lens having the small scale functional material can be designed in which their refractive index can be controlled by an applied electrical field (e.g., a dynamic refractive index lens).

The small scale functional material in the matrix material can also be used in gradient-index (GRIN) optics (e.g., lenses that focus light by changing refractive index rather than thickness and/or curvature). For example, small scale functional materials having different refractive indexes can be dispersed spatially with varying concentrations to create a GRIN lens. Again, the refractive index of the small scale functional materials can be activated by an externally applied field to turn the lens on and off and/or to adjust the focal length of the lens.

The small scale functional material in a matrix material can also be used in light emitting diode (LED) applications. For example, a matrix material having the small scale functional materials can be used in LED package, where higher refractive indexes can be used to improve the angle distribution of light emitted from an LED.

The small scale functional material in the matrix material can also be used to make the matrix material anti-reflective. For example, the matrix material with its small scale functional material can be used in an anti-reflective coating for UV lithography applications. It is also possible to use the matrix material with its small scale functional material as a general purpose anti-reflective material.

For the various embodiments, the small scale functional material can be incorporated into one or more layers of a multi-layer film. For the various embodiments, a layer having the small scale functional material could be used to modify the refractive index of one or more layers of a multi-layer film. This modification could be static or dynamic. For example, a dynamic optical effect (variable wavelength reflectance and transmittance) can be achieved by applying an electric field or a thermal field to change the temperature of the film, where the temperature change can cause the orientation of the polymer(s) in one or more of the layers to become random as the Tg of the layer(s) is reached (e.g., the polymer changes from a more crystalline state to an amorphous state at or above the polymer Tg).

Embodiments of the present disclosure also allow for the small scale functional material to be used in forming a monolith that contains a large volume fraction of the small scale functional material. As used herein, the term monolith refers to a structure (e.g., a film or a coating) that is either formed from or formed of a composition of the small scale functional material in which the vast majority of the volume fraction of the composition is the small scale functional material. Suitable values for the vast majority can include at least 60 percent volume fraction of the composition being the small scale functional material, where the remaining volume fraction can include a volatile liquid species used to suspend the small scale functional material. Other volume fractions of the small scale functional material (e.g., 70 percent and greater, 80 percent and greater) are also possible.

In additional embodiments, the small scale functional materials of the present disclosure can be used in decorative films, electroluminescent films, pigments/inks, brighteners, electromagnetic/electronic applications such as capacitors, transparent conductors, high K/Gate dielectric, underfill thermal paste, magnetic storage media, and optical storage media, among others.

The present disclosure is illustrated by the following examples. It is to be understood that the particular examples, materials, amounts, and procedures are to be interpreted broadly in accordance with the scope and spirit of the disclosure as set forth herein.

### EXAMPLES

Various aspects of the present disclosure are illustrated by the following examples. It is to be understood that the particular examples, materials, amounts, and procedures are to be interpreted broadly in accordance with the scope of the disclosure as set forth herein. Unless otherwise indicated, all parts and percentages are by weight and all molecular weights are number average molecular weight. Unless otherwise specified, all chemicals used are commercially available as indicated herein.

Reagents: methyl methacrylate (MMA, 99 percent, stabilized, Acros Organics); styrene (S, 99 percent, Aldrich), ethylene glycol dimethacrylate (EGDMA, 98 percent, stabilized, Acros Organics); divinylbenzene (DVB, 98 percent, Aldrich); sodium dodecyl sulfate salt (SDS, 98 percent, Acros Organics); 1-pentanol (99 percent, Acros Organics); methylene chloride (HPLC grade, Burdick and Jackson); acetone (HPLC grade, J. T. Baker); liquid crystal substances Licristal® (Merck, KGaA, Darmstadt Germany); poly (methyl methacrylate) of molecular weight 15,000 (Aldrich); butyl acrylate (BA, 99 percent, Stabilized, Aldrich); allyl methacrylate (AMA, Acros Organics, 98 percent); ammonium persulfate (APS, Acros Organics, 98 percent); and N,N,N′,N′-tetramethylethylenediamine (TMEDA, Acros Organics, 99 percent).

All polymerizations are conducted in ultra-pure deionized water (UPDI water, passed through a Barnstead purifier, conductivity <10⁻¹⁷Ω⁻¹) under nitrogen.

### Preparation of Nano-Domains

For the present embodiment, MMA or BA, or S, or mixtures of these monomers are mixed with either AMA, or DVB, which serve as cross linking monomers, according to the amounts provided in Table 1. The mixture is filtered through a column partially packed with basic aluminum oxide (Acros Organics) to remove the stabilizing agents and charged into a 100 ml glass syringe. SDS and 1-pentanol, as provided in Table 1, are combined with the UPDI water and are charged into the reactor where the mixture is stirred at low speed (200 rpm) and purged with nitrogen for 20 minutes at 30° C.

Equimolar amounts of APS and TMEDA are used as the two initiators. APS, as provided in Table 1, in 10 ml of UPDI water is used as a first initiator, and TMEDA, as provided in Table 1, in 10 ml of UPDI water is used as a second initiator for each of the Examples listed in Table 1.

An initial portion of the monomer mixture and the initiators, as provided in Table 1, are charged into a reactor to start the seed polymerization. Injection of the rest of the monomer via a syringe pump (KD Scientific) is started 30 minutes later at a rate as indicated in Table 1. The reactor 100 is purged with nitrogen and the temperature is held at 28° C. throughout the reaction. Polymerization continues for 1 hour. Once the monomer injection is completed, the resulting nano-domains are collected in a glass jar and a few drops of PennStop™ (Aldrich) are added into the jar to stop the polymerization reactions.

TABLE 1

| Component | Example 1 | | Example 2 | | Example 3 | | Example 4 | | Example 5 | |
|---|---|---|---|---|---|---|---|---|---|---|
| Monomer | 33.6 | g | 33.0 | g | 33.6 | g | 16.8 | g | 33.6 | g |
| MMA | | | | | | | | | | |
| Monomer | 0.6 | g | 1.2 | g | 1.2 | g | 0.6 | g | 0.6 | g |
| AMA | | | | | | | | | | |
| Monomer | 0 | g | 0 | g | 0 | g | 16.8 | g | 0 | g |
| BA | | | | | | | | | | |
| Monomer S | 0 | g | 0 | g | 33.6 | g | 0 | g | 0 | g |
| Surfactant | 0.75 | g | 0.675 | g | 6.08 | g | 3.04 | g | 3.04 | g |
| SDS | | | | | | | | | | |
| Surfactant | 0 | g | 0 | g | 2.16 | g | 1.08 | g | 1.08 | g |
| 1-Pentanol | | | | | | | | | | |
| UPDI Water | 255.4 | g | 255.4 | g | 510.8 | g | 255.4 | g | 255.4 | g |
| Initiator | 0.14 | g | 0.14 | g | 0.28 | g | 0.14 | g | 0.14 | g |
| APS | | | | | | | | | | |
| Initiator | 0.07 | g | 0.07 | g | 0.14 | g | 0.07 | g | 0.07 | g |
| TMEDA | | | | | | | | | | |
| Initial | 5.4 | ml at | 10.8 | ml at | 10.8 | ml at | 5.4 | ml at | 5.4 | g at |
| Amount | | | | | | | | | | |
| MMA/Other | 200 | ml/hr | 200 | ml/hr | 200 | ml/hr | 200 | ml/hr | 200 | ml/hr |
| Monomer | | | | | | | | | | |
| Monomer | 8.1 | ml/hr | 23.4 | ml/hr | 16.2 | ml/hr | 8.1 | ml/hr | 8.1 | ml/hr |
| Addition rate | | | | | | | | | | |
| MMA/Other | | | | | | | | | | |
| Monomer | | | | | | | | | | |

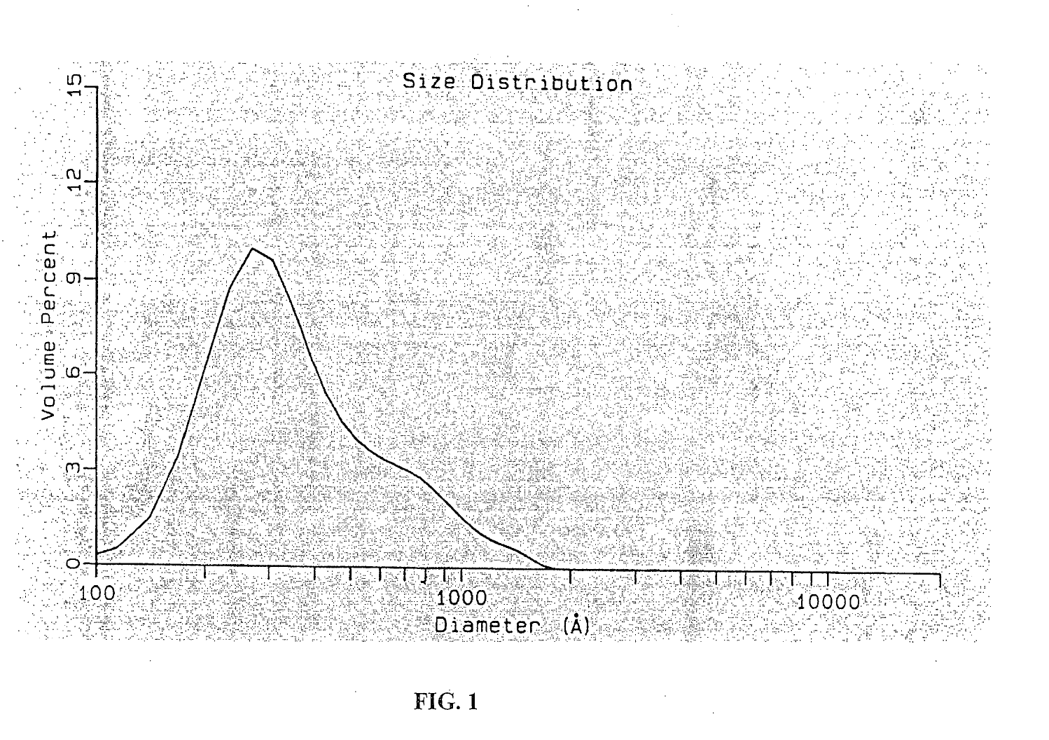

The particle size distribution of the nano-domains of Examples 1-5, as determined by hydrodynamic chromatography (described in “Development and application of an integrated, high-speed, computerized hydrodynamic chromatograph.” Journal of Colloid and Interface Science, Volume 89, Issue 1, September 1982, Pages 94-106; Gerald R. McGowan and Martin A. Langhorst) is shown in FIG. 1. Values for the volume mean diameter for the nano-domain can be from 10 nm to 100 nm. As for the particle size distribution, 70 percent of the nano-domains have a volume mean diameter smaller than 50 nm, where nano-domains having a volume average diameter of 30 nm were found.

The nano-domains are isolated according to one of three methods. In the first method, to a given volume of undiluted nano-domain suspension or latex, an equal volume of methyl ethyl ketone (MEK, Fisher, HPLC grade) is added. The resulting suspension is centrifuged at 2,000 rpm for 20 minutes (IEC Centra GP8R; 1500 G-force). The liquids are decanted and the nano-domains are resuspended in 1× the original volume of 1:1 UPDI water:acetone. The resuspended nano-domains are centrifuged and decanted two additional times. The nano-domains are dried for about 70 hours in a stream of dry air.

In a second method, to a given volume of the undiluted nano-domain suspension or latex, an equal volume of MEK is added. The resulting suspension is centrifuged as above. The liquids are decanted and the nano-domains are blended in UPDI water and added to acetone (equal volume). The nano-domain suspension is filtered, washed with several volumes of methanol (Fisher, HPLC grade) or 1:1 UPDI water:acetone, UPDI water, then methanol. The nano-domains are then dried for about 70 hours in a stream of dry air.

In a third method, to a given volume of the undiluted nano-domain suspension or latex, an equal volume of MEK is added. The resulting suspension is centrifuged as above. The liquids are decanted and the nano-domains are dissolved in a minimum amount of tetrahydrorfuran (THF, Fisher, HPLC grade). The nano-domains are precipitated by adding the THF solution slowly to a 5 to 10-fold excess of methanol. The precipitate nano-domains are filtered and washed with methanol (Fisher, HPLC grade), and then dried as described above.

### Liquid Crystal Substances

A variety of liquid crystal substances are used in the examples provided herein. A first example includes Licristal® E44 (Merck, KGaA, Darmstadt Germany), 4-pentyl-4′-cyano biphenyl, which is a nematic liquid crystal substance with clearing point (transition to isotropic fluid) at 100° C., a dielectric anisotropy (Δε) of +16.8, and optical anisotropy (Δn) of 0.2627. Other liquid crystal substances used in the present examples include 4-Cyano-4′-octylbiphenyl (Frinton Laboratories, NJ); Licristal® E7; Licristal® E63; Licristal® BL006; Licristal® BL048; Licristal® ZLI-4853 and Licristal® MLC-6041 (each from Merck, KGaA, Darmstadt Germany). In the various examples, the liquid crystal substances and/or mixtures of the liquid crystal substances are utilized to observe their influence on order in the nano-domain.

Table 2 displays some of the properties of the liquid crystal substances. The liquid crystal substances are selected at least in part for their high refractive index anisotropy and relatively low switching voltages. With respect to switching voltages, there are two common measures utilized to characterize the switching voltage of liquid crystals. First is a threshold voltage, Vₜₕ, which is the amount of voltage across a display pixel (containing the liquid crystal substance) that is necessary to produce a response. The other is a measure of the “sharpness” of the response and is calculated by finding the difference in voltage necessary to go from a 10 percent to a 90 percent brightness (written as V₁₀-V₉₀). The liquid crystal substances in the present examples have sharp transitions as shown by their V₁₀-V₉₀ values.

TABLE 2

| Liquid Crystal | Clearing Point | Optical | | |
|---|---|---|---|---|
| Substance | (° C.) | Anisotropy, Δn | V₁₀ (V) | V₉₀ (V) |
| Licristal ® E44 | 100 | 0.2627 | 1.64 | 2.23 |
| Licristal ® E7 | 59-60 | 0.286 | nₒ = 1.511 | |
| Licristal ® E63 | 82 | 0.2272 | 1.65 | 2.38 |
| Licristal ® | 115 | 0.286 | Δε = 17.3 | |
| BL006 | | | | |
| Licristal ® ZLI- | 71 | 0.1323 | 1.06 | 1.55 |
| 4853 | | | | |
| Licristal ® | 84 | 0.1584 | 1.13 | 1.26 |
| MLC-6041 | | | | |
| 4-Cyano-4′- | 40.5 | | | |
| octylbiphenyl | | | | |

Imbibing Liquid Crystal Substances into Nano-Domains

A sample of the liquid crystal substance is dissolved in methylene chloride in a glass container, as provided in Table 3, to form a solution. Acetone is added to the solution, which is mixed until a clear solution to the eye is obtained. An aqueous dispersion of the nano-domains are weighed and added to the solution to form a mixture. The mixture is shaken at room temperature (about 21° C.) overnight.

Imbibing the liquid crystal substance into the nano-domains as described above is based on the transport of the liquid crystal molecules across the water-methylene chloride interface into the dispersed nano-domains. There are indications of this process in mixing the aqueous dispersion with the solution. Upon mixing, the aqueous dispersion of nano-domains increases its light scattering power significantly. This suggests an increase in average particle size by either swelling of the nano-domains by the solution or agglomeration of particles. The aqueous dispersion of nano-domains remain stable substantially throughout the mixing, shaking, and decanting processes within the operational ranges; e.g., there is no precipitation of the nano-domains.

The mixture is allowed to phase separate for three hours at room temperature (about 21° C.). Two phases evolve in the container: a methylene chloride rich phase at the bottom of the container, and an aqueous phase on top. The aqueous phase is decanted and freeze-dried to obtain the nano-domains imbibed with the liquid crystal substance. The resulting nano-domains imbibed with the liquid crystal substance has the appearance of a fluffy white powder.

The liquid crystal substances provided in the examples are all successfully imbibed in the nano-domains of Examples 1-5 (above) utilizing the same procedure described above. Table 3 shows the liquid crystal amount in nano-domains of Example 1 imbibed with the various liquid substances. The amount of the liquid crystal substance in the nano-domains vary from about 6 percent to about 25 percent by weight of the small scale functional material. The lowest amount (6.2 percent by weight) corresponds to Licristal® ZLI-4853, followed by Licristal® MLC-6041 (11.6 percent by weight) and Licristal® BL048 (13.2 percent by weight). Licristal® E44 (24.6 percent by weight) and Licristal® E7 (23.1 percent by weight) are imbibed at the highest amount in Example 1 of the nano-domains. Similar results with slightly higher amounts are obtained with nano-domains of Example 1 of 60 nm volume mean diameter.

TABLE 3

| | | Nano- | | | | | |
|---|---|---|---|---|---|---|---|
| | | Domain | | | | | Liquid |
| | Liquid | volume | Liquid | | | Nano- | Crystal |
| | Crystal | mean | Crystal | | | Domain | Substance |
| | Substance | diameter | Substance | MeCl₂ | Acetone | Emulsion | Amount |
| Example | (Licristal ®) | (nm) | wt. (g) | wt. (g) | (g) | wt. (g) | (wt. %) |
| 6 | E7 | 30 | 0.592 | 1.370 | 1.167 | 5.048 | 23.1 |
| 7 | E63 | 30 | 0.565 | 1.341 | 1.146 | 5.004 | 17.2 |
| 8 | MLC- | 30 | 0.586 | 1.345 | 1.163 | 5.035 | 11.6 |
| | 6041 | | | | | | |
| 9 | BL006 | 30 | 0.585 | 1.349 | 1.152 | 5.023 | 20.4 |
| 10 | ZLI-4853 | 30 | 0.578 | 1.355 | 1.166 | 5.010 | 6.2 |
| 11 | BL048 | 30 | 0.566 | 1.354 | 1.147 | 5.037 | 13.2 |
| 12 | E44 | 30 | 5.780 | 13.410 | 11.500 | 50.280 | 24.6 |
| 13 | E7 | 60 | 1.158 | 2.745 | 2.295 | 10.043 | 26.1 |
| 14 | E63 | 60 | 1.165 | 2.714 | 2.306 | 10.005 | 19.7 |
| 15 | BL006 | 60 | 1.153 | 2.701 | 2.327 | 9.999 | 28.4 |
| 16 | BL048 | 60 | 1.153 | 2.742 | 2.302 | 9.999 | 22.6 |
| 17 | MLC- | 60 | 1.154 | 2.697 | 2.435 | 10.011 | 10.1 |
| | 6041 | | | | | | |
| 18 | ZLI-4853 | 60 | 1.161 | 2.696 | 2.310 | 10.016 | 9.7 |

### FTIR Spectroscopy

FTIR spectroscopy (Nicolet 710 FTIR) is utilized to determine the presence and amount of liquid crystal substance imbibed in the nano-domains of Example 1.

For calibration of the FTIR, 0.887 g of poly(methyl methacrylate) is dissolved in 16.78 g of methylene chloride. The mixture is agitated until a clear solution homogeneous to the eye is obtained. To this solution, the necessary amount of liquid crystal substance is added and agitated until the mixture is clear to the eye. The solution is poured onto a release surface (e.g., a sheet) of poly(tetrafluoroethylene), and placed in a vacuum oven operating at room temperature (about 21° C.) to evaporate the methylene chloride. The films obtained are used to calibrate the FTIR measurements.

The small scale functional materials produced are characterized with FTIR and x-ray scattering. FTIR spectroscopy is used to determine the amount of liquid crystal substance in the nano-domains.

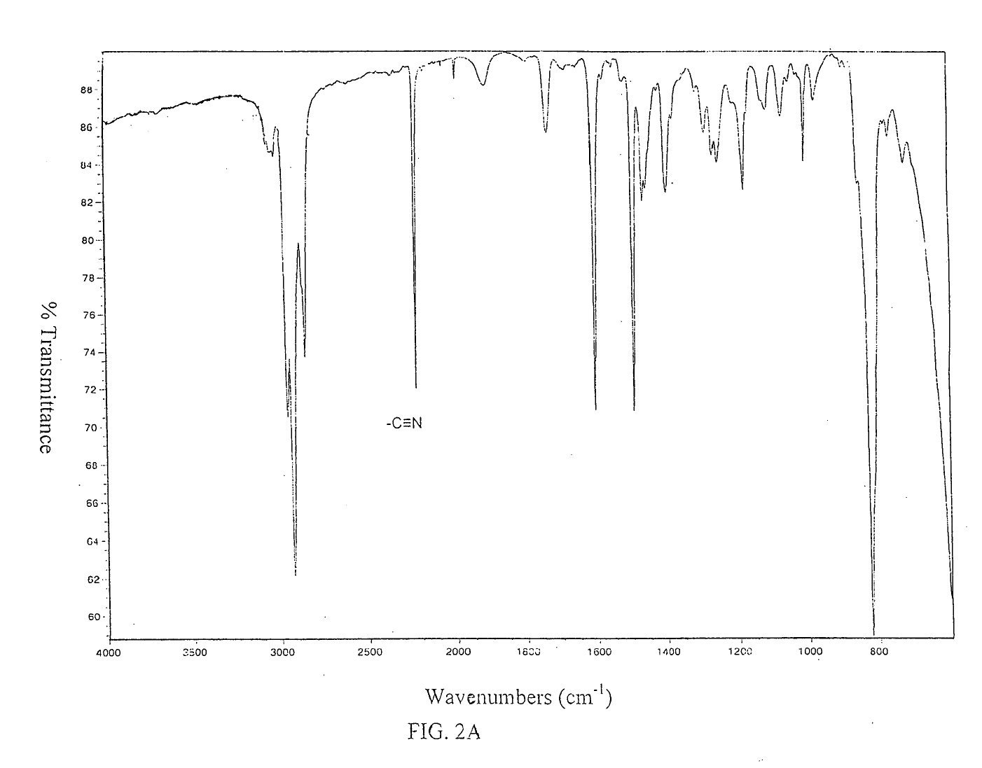

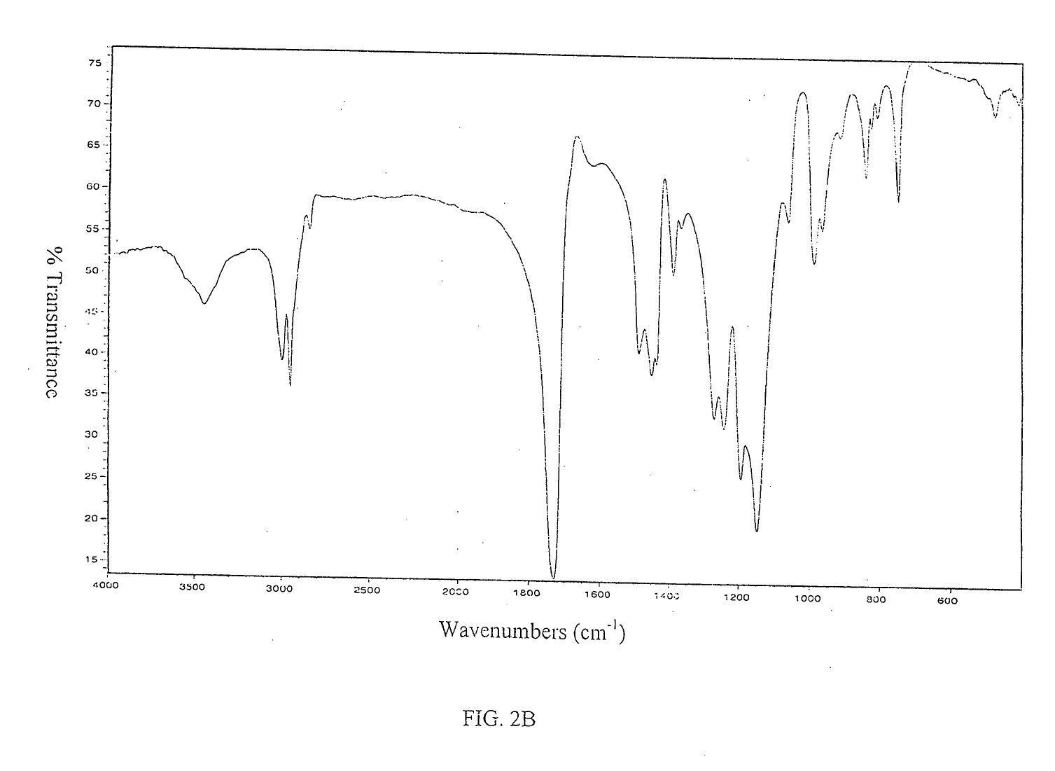

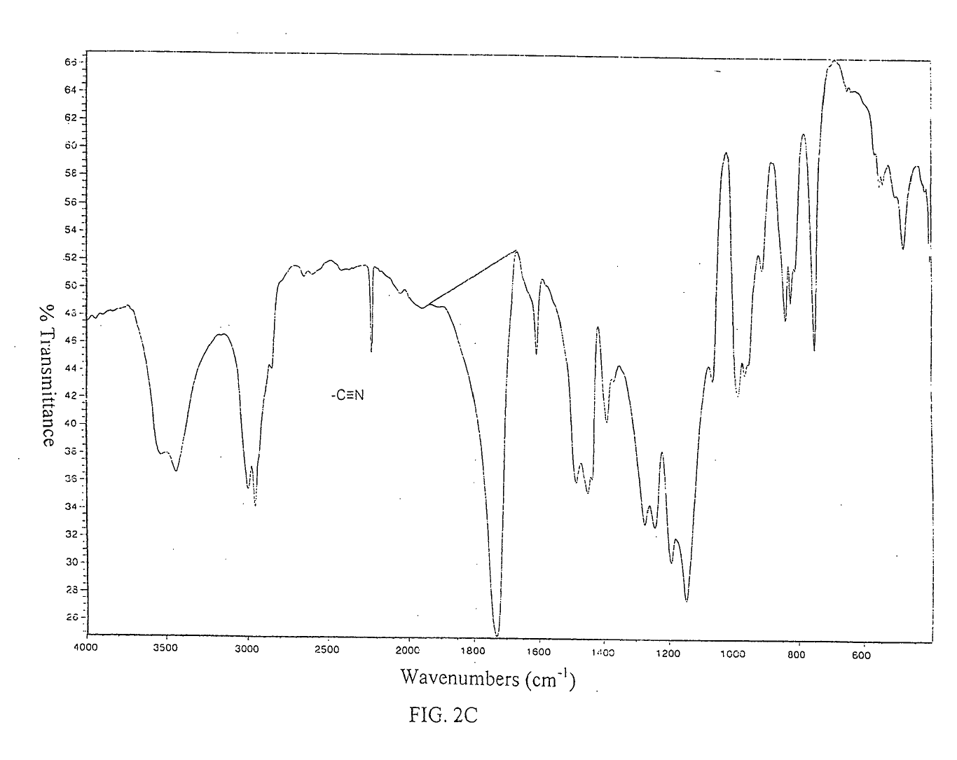

Typical spectra for Licristal® E44, nano-domains of Example 1, and nano-domains of Example 1 imbibed with Licristal® E44 are shown in FIGS. 2A-2C. The FTIR spectrum of Licristal® E44 is characterized by the aromatic C≡N line at about 2230 cm⁻¹ (FIG. 2A). FIG. 2B illustrates the spectra for the nano-domains of Example 1. The spectrum of nano-domains containing Licristal® E44 shows the C≡N band at about 2230 cm⁻¹, which confirms the presence of liquid crystal substances in the nano-domain (FIG. 2C).

The ratio of the C≡N line of the liquid crystal substance to the C═O line (at about 1730 cm⁻¹) of the nano-domain is utilized to determine the liquid crystal substance amount in the nano-domain. Liquid crystal/nano-domain standard compositions of known amount are prepared for calibration. Since all other liquid crystal substances present the aromatic C≡N line, the same method is utilized to characterize the liquid crystal substance amount in the nano-domain particles. Standard compositions are prepared for each liquid crystal substance and nano-domain composition for calibration.

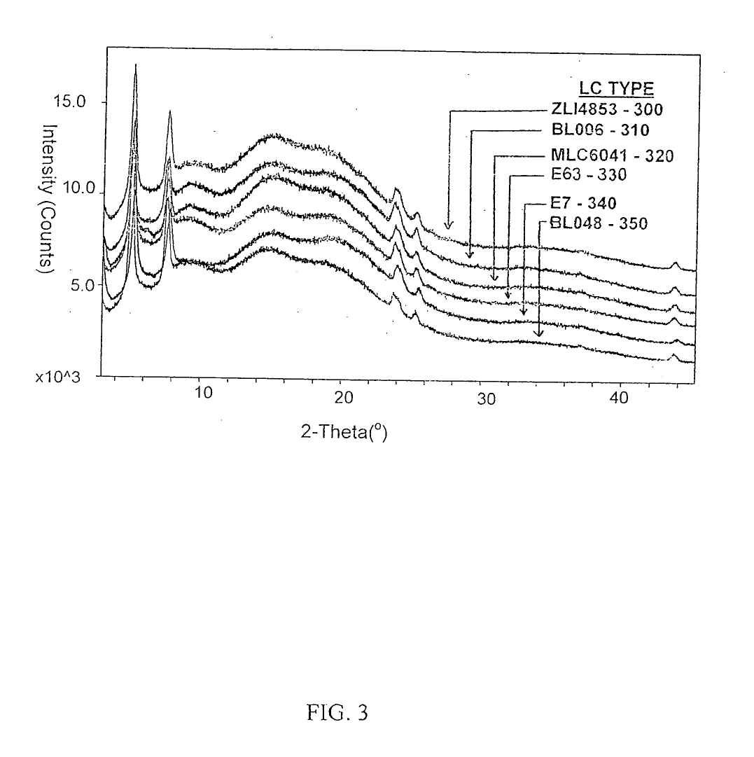

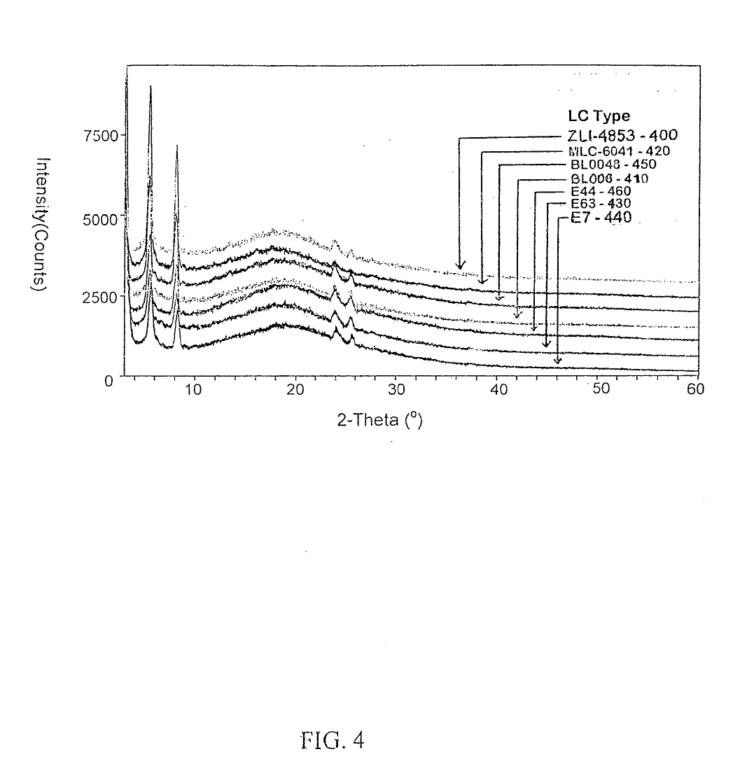

FIG. 3 presents x-ray scattering patterns of the nano-domains of Example 1 that are imbibed with the liquid crystal substances of the examples. As illustrated, the scattering patterns are similar for each of the liquid crystal substances. The scattering bands appear to be located at the same 20 angle for the liquid crystal substances, with only Licristal® E7 showing a very small shift to higher angle (smaller size feature). The scattering peaks correspond to a liquid crystal ordered structure with a characteristic length of 4 nm. This order induced by the nano-domain is not observed in neat liquid crystal substances or in a solution of liquid crystal substances in PMMA. This may suggest that the length scale is determined by the composition and structure of the nano-domain. However, as discussed herein, the nano-domain composition (e.g., co-polymers) does not appear to have a significant impact on the characteristic length for the compositions of the examples. For example, FIG. 4 illustrates that similar results are observed in the nano-domains of Example 3 (MMA/S 1:1) imbibed with the various liquid crystalline materials.

It is additionally observed that an increase in light scattering during the preparation of the imbibed nano-domains is dependent upon the amount of acetone in the liquid crystal substance used in imbibing nano-domains. This suggests an influence of acetone content on the liquid crystal substance being imbibed into the nano-domains. To test this, a study of the factors affecting the imbibing process is performed in which a 3×6 factorial design experiment with one center point is used. A concentration of liquid crystal substance in the imbibing solution and an acetone to liquid crystal substance weight ratio are used as the variables in the study. Preparation temperature and shaking conditions are kept constant during the study.

Table 4 provides the design, variable levels, and liquid crystal substance amount after freeze-drying as determined by FTIR. The maximal concentration of liquid crystal substance in the imbibing solution is 30 percent by weight. The maximal acetone to liquid crystal substance weight ratio is 2.0. This value is limited by the stability of the aqueous dispersion of nano-domains. A higher concentration of acetone initiates the agglomeration and precipitation of the particles out of the dispersion. The maximal Licristal® amount imbibed in the dry nano-domains is 20 percent by weight in these experiments.

TABLE 4

| | Licristal ® | | Liquid | Weight of | | |
|---|---|---|---|---|---|---|
| | E44 | | Crystal | Licristal ® | Capsule | |
| | Conc. in | | Substance | E44 | suspension | |
| Factorial | MeCl₂ | Acetone/E44 | Amount | solution | (11.5% by | Acetone |
| Pattern | (wt. %) | weight ratio | (wt. %) | (g) | wt.) (g) | (g) |
| 3 × 5 | 30 | 1.8 | 18 | 1.92 | 5 | 1.04 |
| 3 × 4 | 30 | 1.6 | 17.7 | 1.92 | 5 | 0.92 |
| 3 × 3 | 30 | 1.21 | 14.1 | 1.92 | 5 | 0.7 |
| 2 × 5 | 20 | 1.8 | 11.6 | 2.875 | 5 | 1.04 |
| 3 × 2 | 30 | 0.87 | 12.5 | 1.92 | 5 | 0.5 |
| 3 × 1 | 30 | 0.34 | 11.3 | 1.92 | 5 | 0.2 |
| 1 × 4 | 11.5 | 1.6 | 6.1 | 5 | 5 | 0.92 |
| 2 × 2 | 20 | 0.87 | 9.1 | 2.875 | 5 | 0.5 |
| 1 × 2 | 11.5 | 0.87 | 5.6 | 5 | 5 | 0.5 |
| 2 × 4 | 20 | 1.6 | 11.1 | 2.875 | 5 | 0.92 |
| 1 × 3 | 11.5 | 1.21 | 5.7 | 5 | 5 | 0.7 |
| 2 × 6 | 20 | 2 | 12.5 | 2.875 | 5 | 1.15 |
| 3 × 6 | 30 | 2 | 20.7 | 1.92 | 5 | 1.15 |
| 1 × 6 | 11.5 | 2 | 7.6 | 5 | 5 | 1.15 |
| 1 × 1 | 11.5 | 0.34 | 3.8 | 5 | 5 | 0.2 |
| 1 × 5 | 11.5 | 1.8 | 5.2 | 5 | 5 | 1.04 |
| 2 × 3 | 20 | 1.21 | 10.5 | 2.875 | 5 | 0.7 |
| 2 × 1 | 20 | 0.34 | 7.9 | 2.875 | 5 | 0.2 |
| 0 × 0 | 15.75 | 0.605 | 6.2 | 3.65 | 5 | 0.35 |

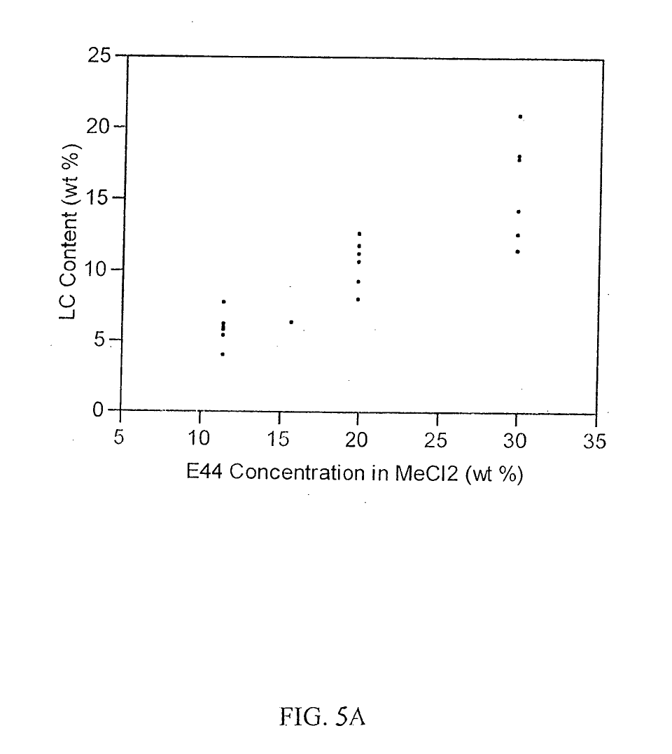

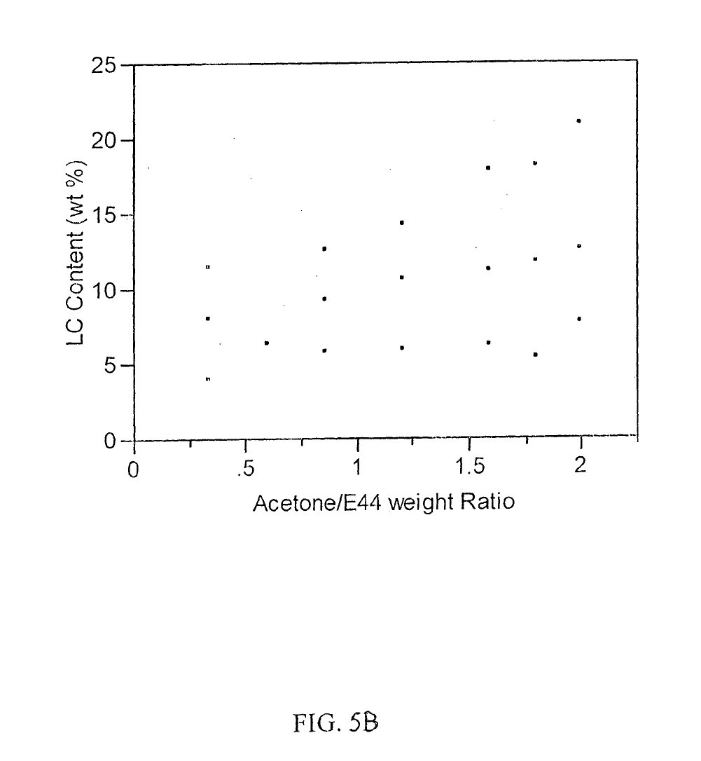

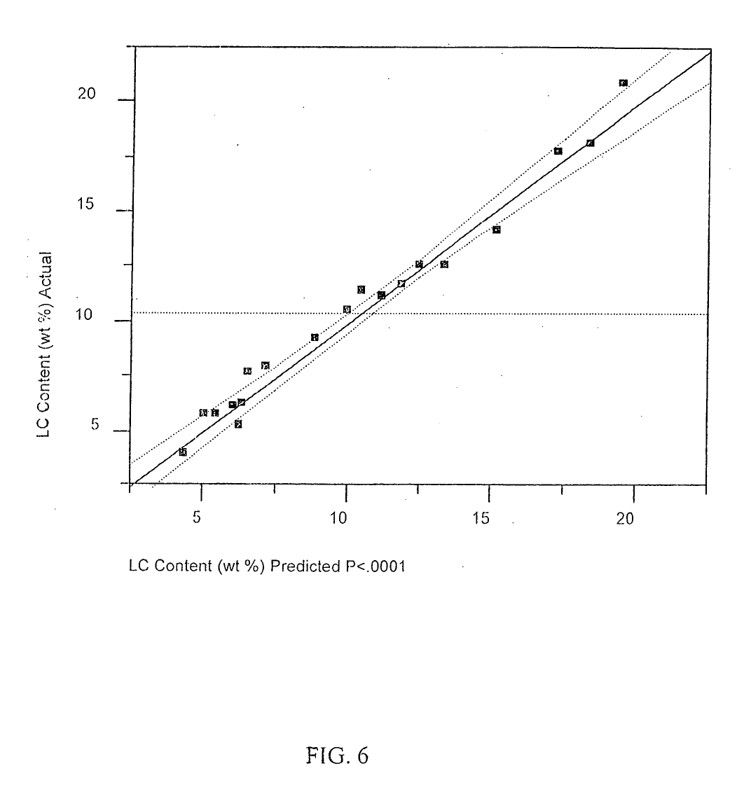

FIGS. 5A and 5B show the amount of liquid crystal substance imbibed in the nano-domain of Example 1 as a function of the concentration of Licristal® E44 in the methylene chloride precursor solution for various acetone/Licristal® E44 weight ratios (FIG. 5A), and acetone to Licristal® E44 weight ratio in the precursor solution for various concentrations of Licristal® E44 in the precursor solution (FIG. 5B). Both curves indicate a direct correlation between the liquid crystal substance amount in the dry nano-domain and both variables. The amount of liquid crystal substance in the dry nano-domain increases directly with the concentration of liquid crystal substance in the imbibing solution and the acetone to liquid crystal substance weight ratio. In addition, there is an inter-relationship between the two variables discussed above. The results of a least square fit model of the amount of liquid crystal substance in the dry nano-domain are shown in FIG. 6. A statistically significant fit of the data (R²=0.9799) is obtained when the two variables and a cross term are utilized (as shown by the analysis of variance P<0.0001 for the three terms). According to this fit, the amount of liquid crystal substance in the dry nano-domains can be expressed as follows:

% LC=−4.657+0.536 LCS %+3.278 AC/LC Ratio+0.22 (LCS %×AC/LC ratio)

where % LC is the amount of liquid crystal substance in the dry nano-domains; LCS % is the concentration of liquid crystal substance in the imbibing solution; AC/LC Ratio is the weight ratio of acetone to liquid crystal substance in the imbibing solution; and (LCS %×AC/LC Ratio) is the cross term. The fitted model also incorporates a non-zero intercept. This fit appears to explain about 98 percent of the variation in liquid crystal substance amount in the nano-domain caused by the concentration of liquid crystal substance and acetone to liquid crystal substance weight ratio in the imbibing solution.

Licristal® E44 is sold as a nematic liquid crystal substance. The liquid crystal maintains its orientational order up to the clearing point at which the liquid crystal becomes an isotropic fluid (100° C.). Imbibing the liquid crystal substances into nano-domains may impact the morphology of the liquid crystal and/or the nano-domains. X-ray scattering techniques are utilized to probe the morphology of the liquid crystal substance imbibed nano-domains.

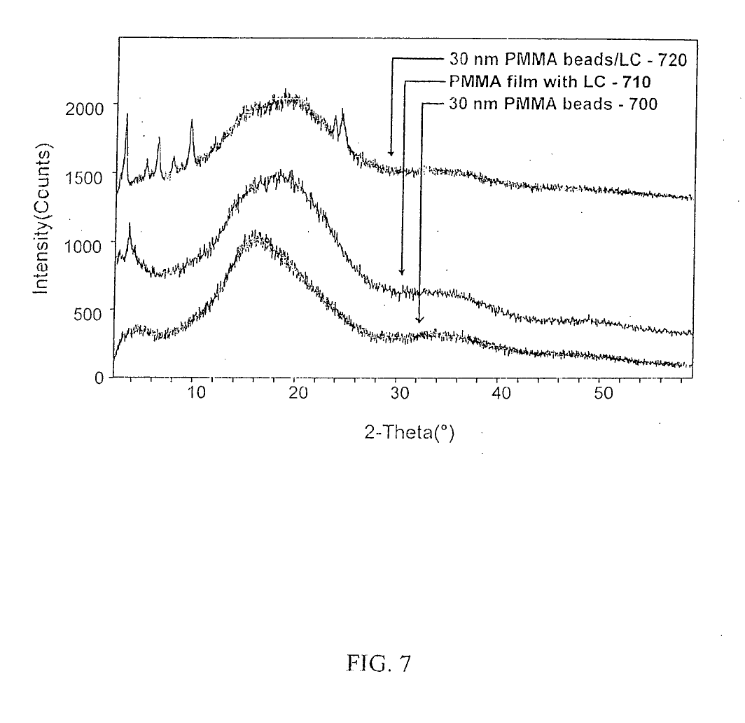

The x-ray scattering patterns of selected materials are presented in FIG. 7. The scattering pattern corresponding to the nano-domains of Example 1, without liquid crystal substance, is represented by curve 700. This curve shows a broad halo of an amorphous polymeric material without a specific structural arrangement. Curve 710 corresponds to a solution of Licristal® E44 in PMMA polymer. This curve presents a very similar amorphous pattern with a small peak at higher angle indicative of a crystalline or smectic liquid crystal phase. In contrast, curve 720 corresponds to the nano-domains of Example 1 imbibed with Licristal® E44 having several diffraction peaks indicating the presence of smectic or crystalline order with the leading peak representative of a 40 angstrom (Å) feature. This feature length is consistent with bilayer d-spacing in Licristal® E44.

### Process Temperature

The effect of temperature on the imbibing process is tested for Licristal® E44 imbibed in nano-domains of Example 1. Temperatures between ambient (21° C.) and 50° C. are analyzed. The highest temperature is selected to prevent instability of the nano-domain/imbibing solution bi-phasic system and to avoid precipitation of the nano-domains in the imbibing process.

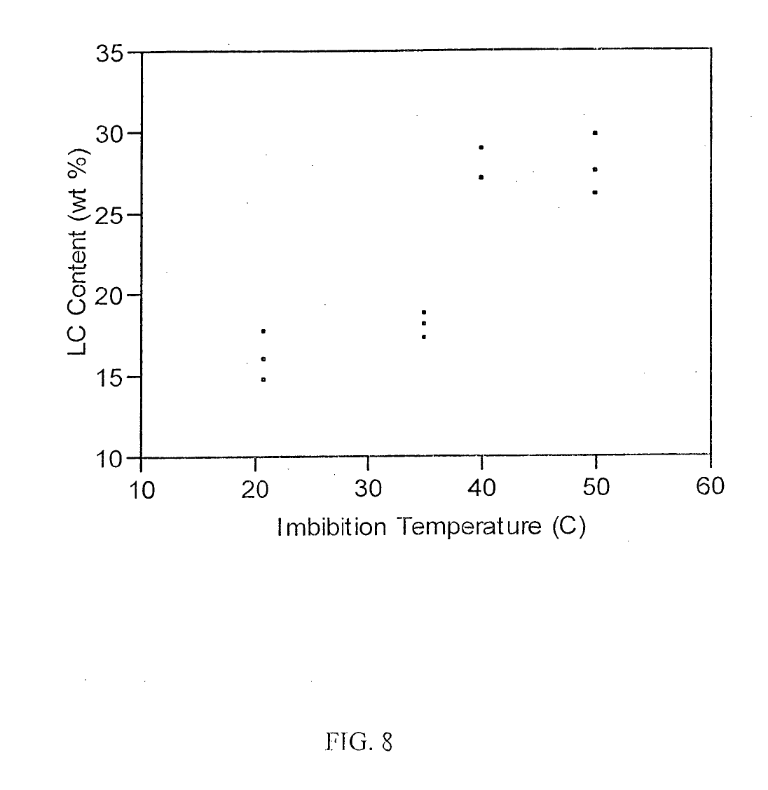

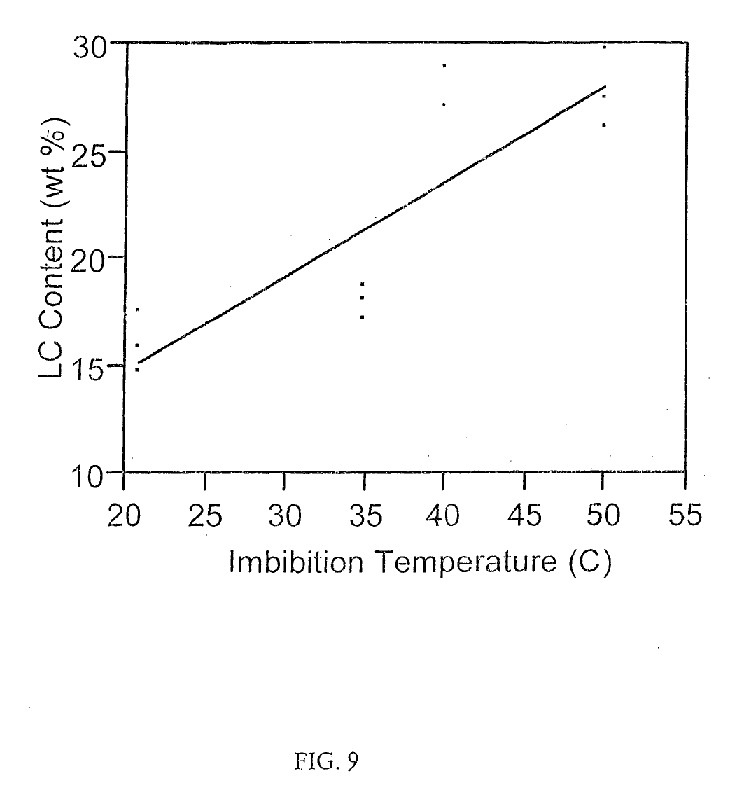

Table 5 and FIG. 8 present the liquid crystal substance amount in the nano-domains as a function of the imbibing temperature. The data suggests that the higher imbibing temperatures promote higher liquid crystal substance amounts in the nano-domains. FIG. 9 illustrates the results of a least squares fit model of the amount of Licristal® E44 imbibed in the nano-domains of Example 1 as a function of temperature. A statistically significant fit of the data is obtained (with R²=0.7396, and analysis of variance P<0.0007) that indicates that about 75 percent of the variation in the amount of liquid crystal substance in the nano-domains is attributable to the effect of temperature. The analysis provides a temperature coefficient of 0.44 for the amount of Licristal® E44 on the nano-domains of Example 1.

TABLE 5

| | Liquid Crystal Substance Amount |
|---|---|
| Temperature (° C.) | (wt. %) |
| 21 | 15.9 |
| 21 | 17.5 |
| 21 | 14.7 |
| 35 | 17.2 |
| 35 | 18.0 |
| 35 | 18.7 |
| 40 | 28.8 |
| 40 | 27.0 |
| 50 | 27.4 |
| 50 | 26.1 |
| 50 | 29.7 |

### Nano-Domain Size

X-ray scattering data indicates that the nano-domains of Example 1 imbibed with Licristal® E44 have several diffraction peaks indicating the presence of smectic or crystalline order with the leading peak representative of a 40 Å feature. This feature length is consistent with bilayer d-spacing in Licristal® E44. Based on these findings, nano-domains of larger size are made to better understand whether the composite morphology of the nano-domain is affected. Table 6 presents the composition of nano-domains of Example 1 having 30 nm and 60 nm size which are imbibed with a variety of liquid crystal substances. The results indicate that the amount of liquid crystal substance in the nano-domains is slightly higher for larger nano-domains. For example, 30 nm nano-domains imbibed with Licristal® E7 present 23.1 wt. percent of liquid crystal substance. Sixty nanometer nano-domains imbibed with the same liquid crystal substance contain 26.1 wt. percent. Other liquid crystal substances show a similar increase in amount as the nano-domain's size increases from 30 nm to 60 nm. This change in the liquid crystal substance amount, however, is not believed to be significant enough to suggest that the nano-domains/liquid crystal morphology is one of core-shell nature.

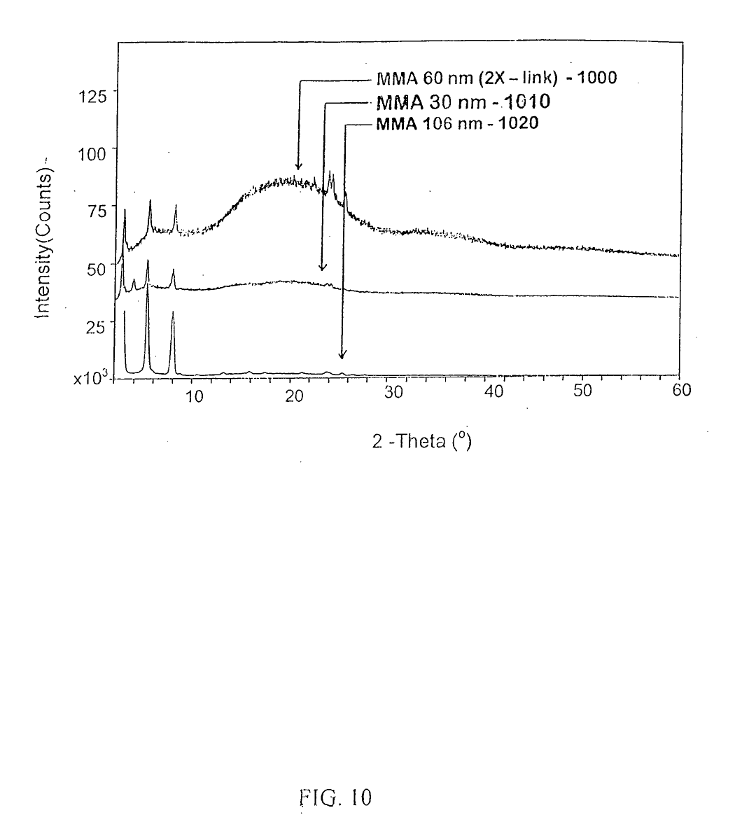

The x-ray scattering patterns of nano-domains of Example 1 of 30 nm and 106 nm and imbibed Licristal® E44 are shown in FIG. 10. The main scattering features are similar for both compositions and are indicative of similar ordered structures. The main peaks are consistent with a characteristic length of 4 nm in both cases. FIG. 10 also presents the scattering pattern for 60 nm nano-domains whose cross-link density is increased by utilizing twice the concentration of AMA in the micro-emulsion polymerization. This pattern has similar features to all others with the same associated characteristic length (4 nm). The liquid crystal substance amount (Licristal® E44) in these nano-domains is 23.2 wt. percent (Table 6) which is similar to that of 30 nm nano-domains (24.6 wt. %) with half the level of cross-linking agent. This suggests that the higher level of cross-linking agent in these nano-domains does not prohibit imbibing the liquid crystal substance with the processes and conditions utilized for these examples.

TABLE 6

| | | | | | | | Nano- | Liquid |
|---|---|---|---|---|---|---|---|---|
| | | | | Liquid | | | Domain | Crystal |
| | Liquid | Nano- | Nano- | Crystal | | | Emulsion | Substance |
| | Crystal | Domain | Domain | Substance | MeCl₂ | Acetone | wt. | Amount |
| Ex. | Substance | Composition | Size (nm) | wt. (g) | wt. (g) | wt. (g) | (g) | (wt. %) |
| 19 | Licristal ® | Ex. 1 | 30 | 5.780 | 13.410 | 11.500 | 50.280 | 24.6 |
| | E44 | | | | | | | |
| 20 | Licristal ® | Ex. 1 | 106 | 1.818 | 2.870 | 1.389 | 10.070 | — |
| | E44 | | | | | | | |
| 21 | Licristal ® | Ex. 2 | 60 | 5.750 | 13.520 | 11.560 | 50.040 | 23.2 |
| | E44 | | | | | | | |
| 22 | Licristal ® | Ex. 3 | 30 | 1.173 | 2.707 | 2.310 | 10.053 | 17.8 |
| | E44 | | | | | | | |
| 23 | Licristal ® | Ex. 4 | 40 | 1.951 | 2.836 | 2.876 | 12.520 | 24.4 |
| | E44 | | | | | | | |
| 24 | Licristal ® | Ex. 3 | 30 | 1.153 | 2.700 | 2.337 | 10.010 | 6.4 |
| | E7 | | | | | | | |
| 25 | Licristal ® | Ex. 3 | 30 | 1.169 | 2.704 | 2.308 | 10.044 | 15.7 |
| | E63 | | | | | | | |
| 26 | Licristal ® | Ex. 3 | 30 | 1.177 | 2.706 | 2.308 | 10.098 | 18.0 |
| | BL006 | | | | | | | |
| 27 | Licristal ® | Ex. 3 | 30 | 1.167 | 2.698 | 2.306 | 10.020 | 11.3 |
| | BL048 | | | | | | | |
| 28 | Licristal ® | Ex. 3 | 30 | 1.161 | 2.715 | 2.304 | 10.032 | 12.8 |
| | MLC- | | | | | | | |
| | 6041 | | | | | | | |
| 29 | Licristal ® | Ex. 3 | 30 | 1.164 | 2.714 | 2.300 | 10.045 | 12.9 |
| | ZLI- | | | | | | | |
| | 6041 | | | | | | | |
| 30 | 4-Cyano- | Ex. 1 | 30 | 1.167 | 2.698 | 2.306 | 10.020 | 11.8 |
| | 4′-octyl | | | | | | | |
| | biphenyl | | | | | | | |
| 31 | 4-Cyano- | Ex. 3 | 30 | 1.173 | 2.707 | 2.310 | 10.053 | 16.6 |
| | 4′-octyl | | | | | | | |
| | biphenyl | | | | | | | |

### Nano-Domain Composition

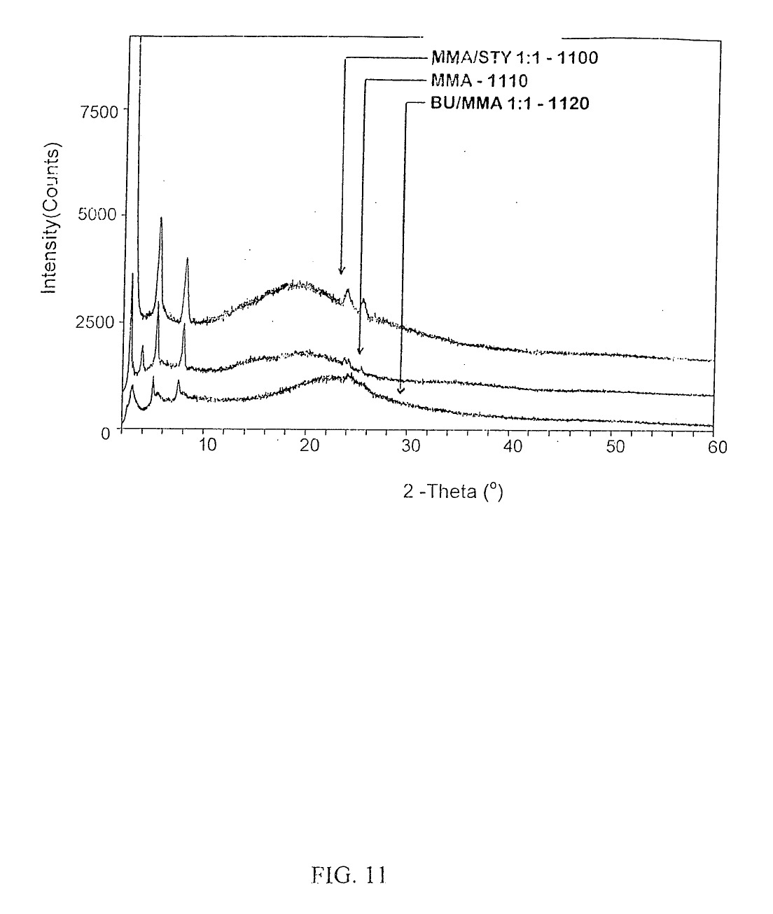

FIG. 11 shows x-ray scattering patterns of nano-domains of various compositions imbibed with Licristal® E44. The three compositions are Examples 1, 3, and 4 from Table 1. The three nano-domains compositions have a volume mean diameter of about 30 to about 40 nm. These patterns indicate ordered structures in all compositions. The main scattering features are similar for all compositions and are located at the same angles. The main peaks are consistent with a characteristic length of 4 nm. Nevertheless, there are small differences in the patterns. For example, the nano-domain of Example 1 presented a small peak at 2θ=2.5° that does not appear in the nano-domains of Examples 3 and 4.

### Film Forming Characteristics of the Small Scale Functional Material

A film forming solution for each of three different small scale functional materials (Examples 19, 27, and 30, above) are prepared as discussed herein. Each film forming solution is formed with 0.2 g of the small scale functional material (Examples 19, 27, and 30 in powder form) suspended in 90 g of toluene (Aldrich, HPLC grade), 9.4 g of dibutyl maleate (Aldrich, 99.9 percent), and 0.2 g of BYK-320 (a silicone leveling agent, BYK Chemie) at 20° C. for 20 minutes. Surprisingly, it is discovered that there is a sudden drop in haze percentage measurements for films formed with film forming solutions having about 9 to about 10 percent by weight dibutyl maleate with the toluene.

Films for each of the three small scale functional materials are formed by a draw coating process. For the process, a 200 μL sample of the film forming solution is deposited on a glass slide, across which a draw bar of height equal to 0.020 in. is drawn at 3.8 inches/sec using an automatic draw machine (Gardco, DP-8201). The samples are allowed to fully dry and have a thickness of about 36.2 μm.

Each of the films formed with the above film forming solutions had a total haze of between less than about 2 percent haze (measured as discussed below), and a total transmittance of 90 percent or greater (measured as discussed below) while on the glass substrate. With these low haze and high transmittance results, the behavior of the small scale functional materials as film formers with high-quality optics (low haze and high transmittance) may enable the use of such materials for optical applications such as phase retardation films, lenses, gradings, anti-reflective coatings, and privacy coatings, among other applications.

### Optical and Electro-Optical Performance Characteristics of Film

A film forming solution with the nano-domain of Example 1 (without imbibed liquid crystal substance) and a film forming solution with a small scale functional material of the nano-domains of Example 1 imbibed with 22 wt. percent of Licristal® E44 are prepared as discussed herein (0.2 grams of the nano-domain of Example 1 or the small scale functional material suspended in 90 grams of toluene, 9.4 grams of dibutyl maleate, and 0.2 grams of BYK-320). Each of the two film forming solutions are used to form a film by a spin coating process, in which a 5 ml sample of the film forming solution is flooded onto a surface of a 10.16 cm diameter silicon wafer that is spun at 3,000 RPM for 90 seconds. The films are allowed to dry at room temperature and have a thickness of about 2 to about 7 micrometers.

The film formed with the nano-domains of Example 1 (without imbibed liquid crystal substance) have a refractive index of 1.4753 at 632.8 nm measured by a Metricon 2010 Prism coupler. The film formed with the small scale functional material having the nano-domains of Example 1 and imbibed with 22 wt. % of Licristal® E44 have a refractive index of 1.5124 at 632.8 nm measured by a Metricon 2010 Prism coupler. This refractive index data suggests that the influence of the refractive index of a liquid crystal substance can be expressed in the optical characteristics of a film formed with the small scale functional material.

Compared to the film formed with the nano-domains of Example 1 (without imbibed liquid crystal substance), the film formed with the small scale functional material having the nano-domains of Example 1 imbibed with the 22 wt. % of Licristal® E44 produces a change in the refractive index of 0.037, which provides a significant phase retardation effect of about 185 nm. Additionally, this effect may be multiplied (or tuned according to the application) by adjusting a thickness of the film, e.g., a 23 μm thick film formed with the nano-domains and the small scale functional material discussed above can produce a phase retardation effect of 851 nm. This type of performance can provide for the application needs of a large portion of the liquid crystal display industry.

### Capacitance-Voltage Sweeps of Liquid Crystal Polymeric Systems

Capacitance-voltage (C-V) sweeps are used to study the switching ability of the liquid crystal substance once imbibed into the nano-domain. The C-V sweeps are also used to determine changes in a refractive index for composites of liquid crystal substances and the polymers used in forming the nano-domains. The C-V sweeps allow the determination of changes in the refractive index for composites of liquid crystal substances and polymers by assuming that measured changes in capacitance are directly proportional to the dielectric constant of the film, which is proportional to the refractive index squared. Metricon prism coupling method is also used to compliment the C-V approach and is used to measure the refractive index of the coatings.

Two systems are studied: direct mix and nano-domain. In the direct mix systems, the liquid crystal substance is added directly to a polymer solution and mixed. Two polymer chemistries are used for the direct mix system, PMMA and PVC. In the nano-domain system, a solution of liquid crystal substance in an organic solvent is added to an emulsion of nano-domains of Example 1, as described above.

For the systems, a variety of liquid crystal substances are studied, including Licristal® E44 from Merck, 4-cyano-4′-octylbiphenyl (octyl), 4-cyano-4′-pentylbiphenyl (phenyl) and p-methocybenzylidene p-butylanaline (analine). The nano-domains or polymers are dissolved in either toluene or a 50:50 (wt./wt.) mixture of cyclohexanone (CHO) and toluene (TOL). All solutions are spin-coated onto silicon wafers in a clean room and baked for 30 seconds at 80° C. They are then metallized with Al dots for capacitance measurements.

The solutions used in the C-V sweeps are listed in Table 7. As discussed, prism coupling (Metricon 2010 Prism Coupler, Metricon Corp) is also used to measure the refractive index (RI) at 60,032.8 nm and profilometry to measure the film thickness. The refractive index measurements in Table 7 are used to adjust the capacitance measurements such that the square root of the calculated dielectric constant from the C-V is equal to the measured refractive index at 0 V.

TABLE 7

| | | | | | Liquid | |
|---|---|---|---|---|---|---|
| | | | | Liquid | Crystal | |
| | | | | Crystal | Substance | |
| Sample | Type | Solvent | Polymer | Substance | (wt. %) | RI |
| PMMA Control | Control | CHO:TOL | PMMA | None | 0 | 1.4955 |
| 6% 4-Cyano-4′- | Direct | CHO:TOL | PMMA | octyl | 6 | 1.5128 |
| octylbiphenyl in | | | | | | |
| PMMA | | | | | | |
| 7% Licristal ® | Nano | TOL | None | Licristal ® | 7 | 1.5092 |
| E44-PMMA- | | | | E44 | | |
| Nano-Domain | | | | | | |
| 7% Licristal ® | Nano | CHO:TOL | PMMA | Licristal ® | 0.6 | 1.4954 |
| E44 Nano- | | | | E44 | | |
| Domain/PMMA | | | | | | |
| PMMA Control | Control | CHO:TOL | PMMA | None | 0 | 1.4753 |
| 22% Licristal ® | Nano | CHO:TOL | None | Licristal ® | 22 | 1.5124 |
| E44-PMMA | | | | E44 | | |
| Nano-Domain | | | | | | |
| 22% Licristal ® | Nano | CHO:TOL | PMMA | Licristal ® | 11.4 | 1.4960 |
| E44-Nano- | | | | E44 | | |
| Domain- | | | | | | |
| PMMA | | | | | | |
| 14% Licristal ® | Nano | TOL | None | Licristal ® | 4 | 1.5015 |
| E44-PMMA | | | | E44 | | |
| Nano-Domain | | | | | | |

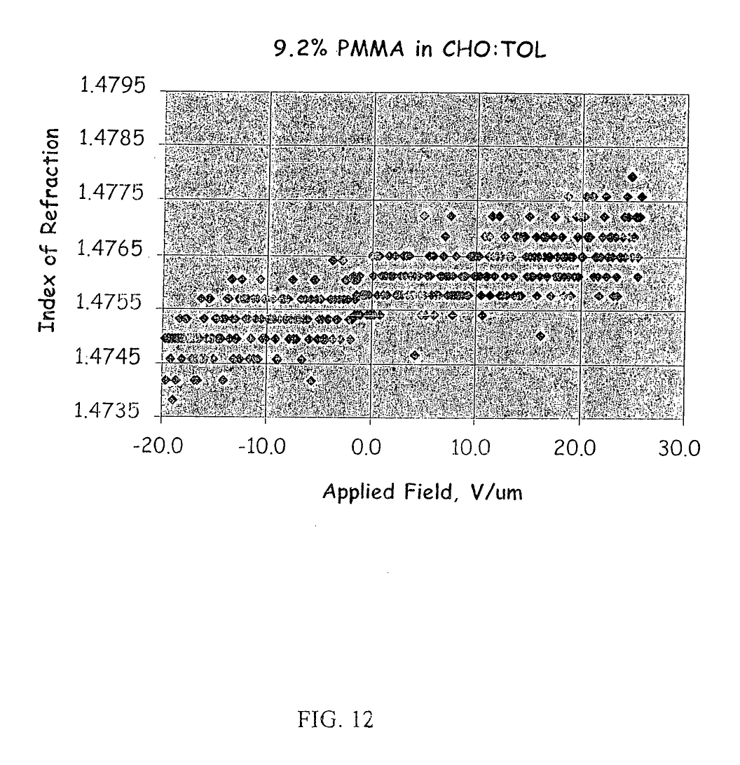

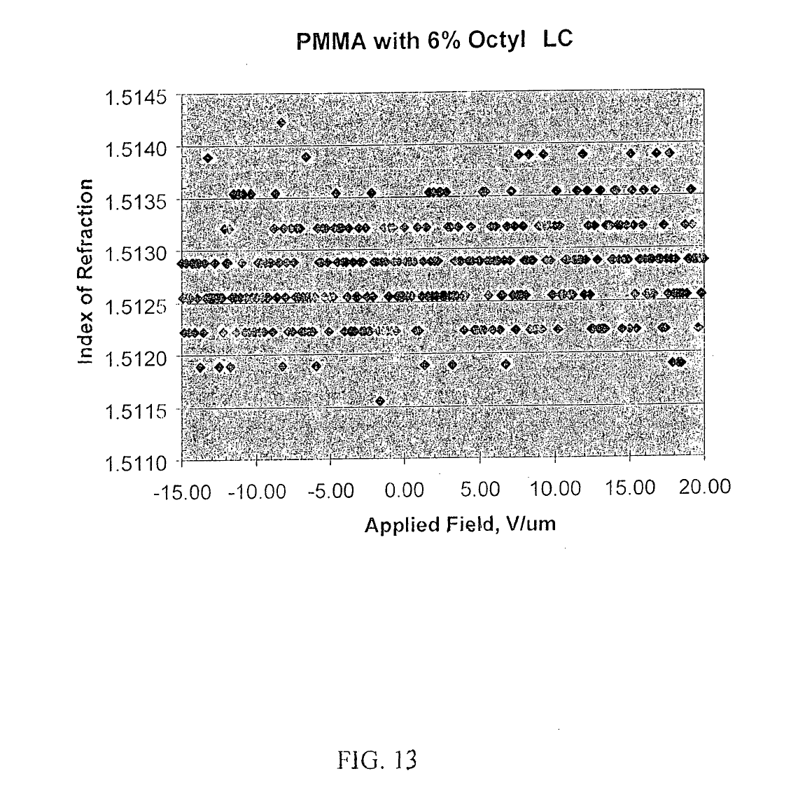

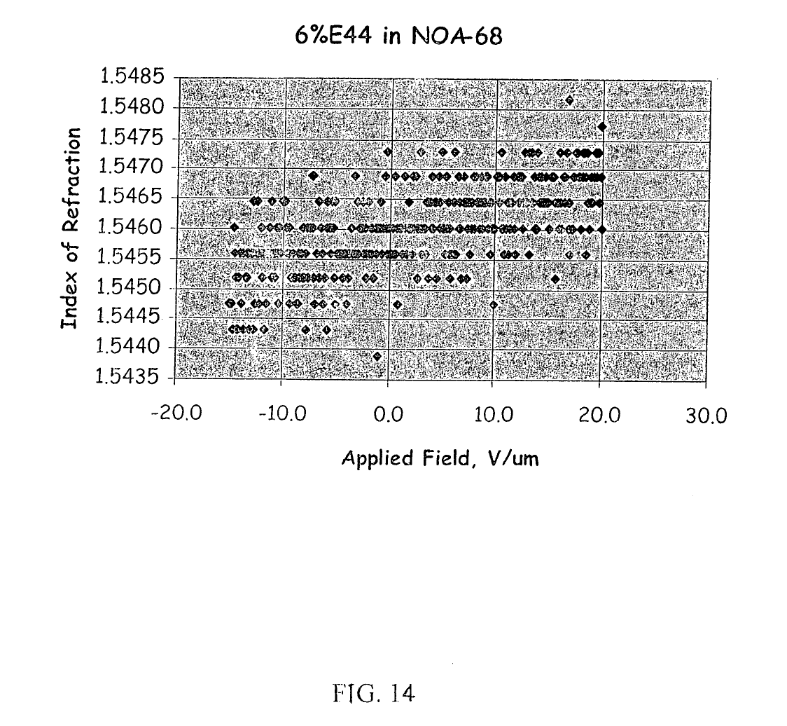

FIG. 12 shows the C-V results for neat PMMA with no liquid crystal substance or liquid crystal-nano-domains added. The baseline is fairly stable with perhaps a slight drift in capacitance with applied electric field. In FIG. 13, the C-V sweep for the neat PMMA solution with 6 wt. percent octyl liquid crystal substance is plotted. Again, the capacitance or refractive index shows no strong function with externally applied field. This suggests that the liquid crystal substance as directly mixed is not cooperatively orienting during the application of the electric field. Similarly, in FIG. 14 Licristal® E44 is dissolved directly into a common optical resin (NOA-68) and again no strong effect between the capacitance and the externally applied field is observed.

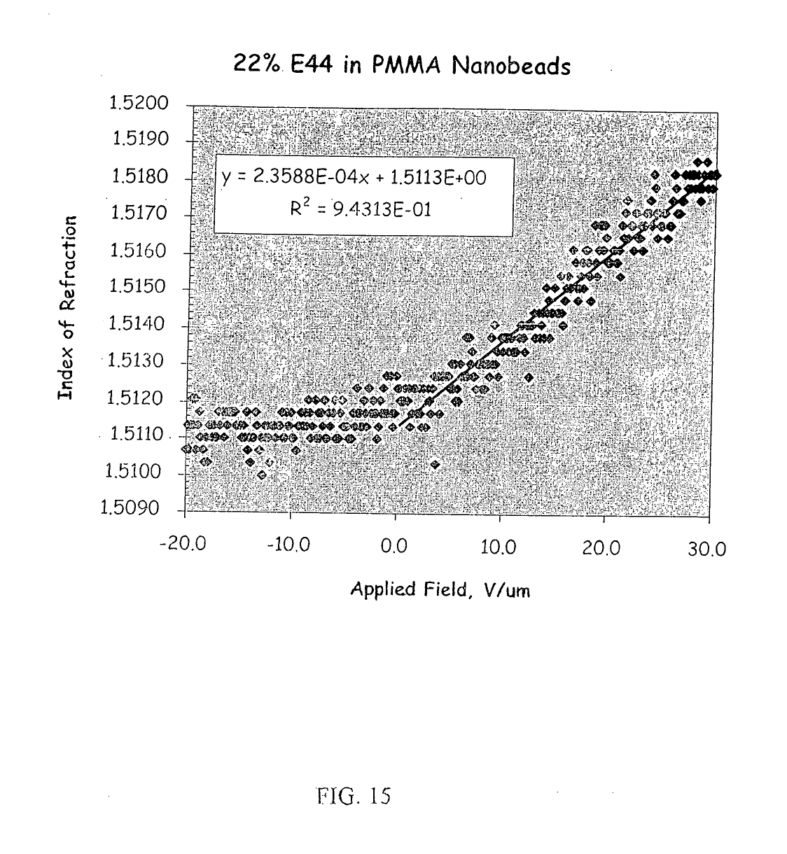

FIG. 15 plots the C-V sweep of 22 wt. percent Licristal® E44 imbibed into PMMA nano-domains. There is a strong increase in the capacitance or refractive index with the application of positive electric field. This result is consistent with the model of domains of liquid crystal substances being dispersed in the polymer latex particle allowing the liquid crystal substance to cooperatively rotate under the influence of the electrical field.

In addition, the electro-optical activity of the liquid crystal substance remains when the liquid crystal substance is imbibed in the nano-domain. The C-V sweeps show that the imbibed liquid crystal substance's dielectric constant changes with voltage applied. This suggests molecular alignment under the externally applied field. This change in dielectric constant is directly related to refractive index anisotropy of the liquid crystal substance and can allow tunable optical behavior at these small scales.

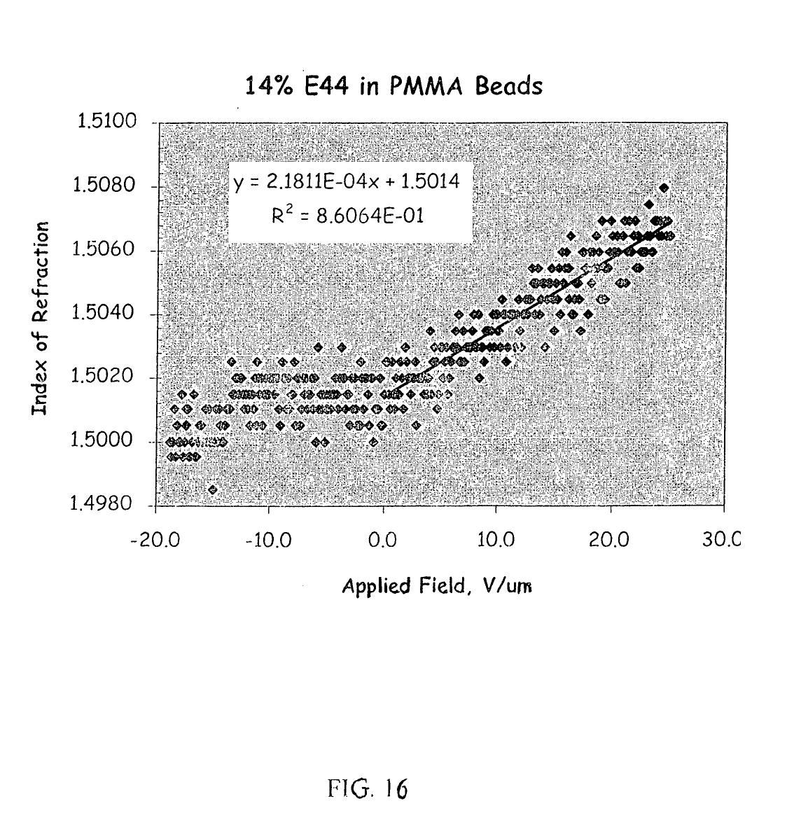

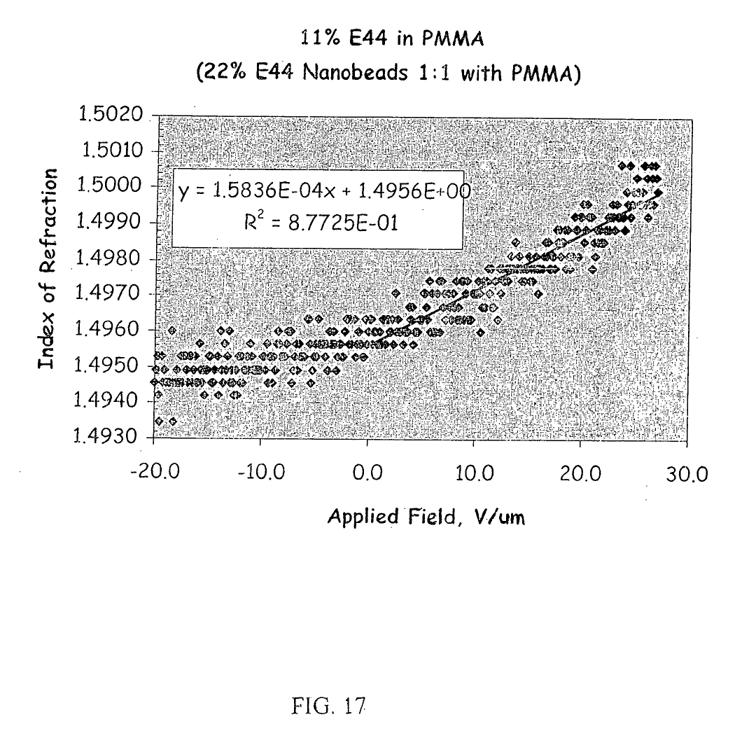

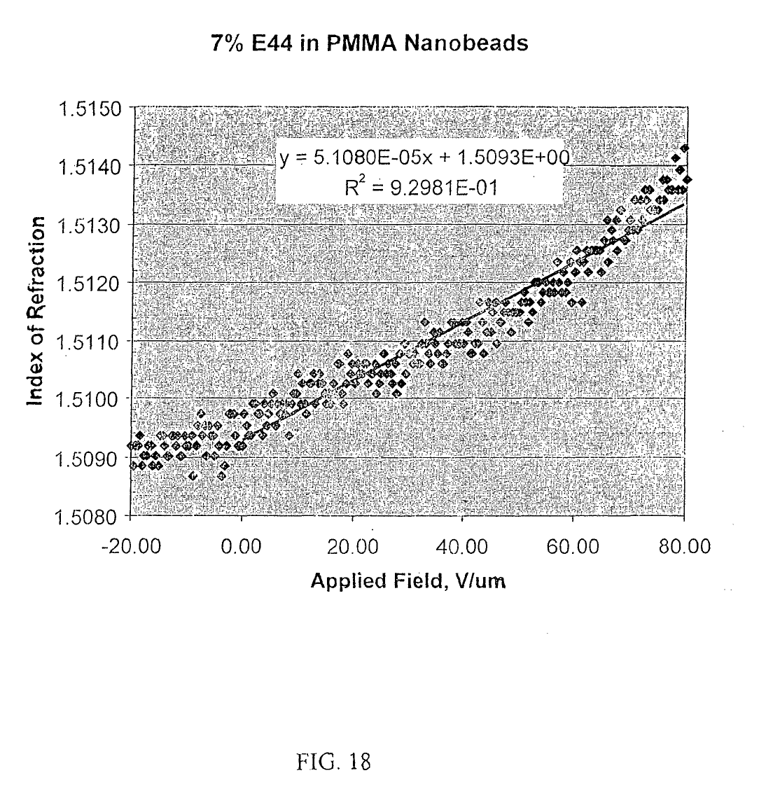

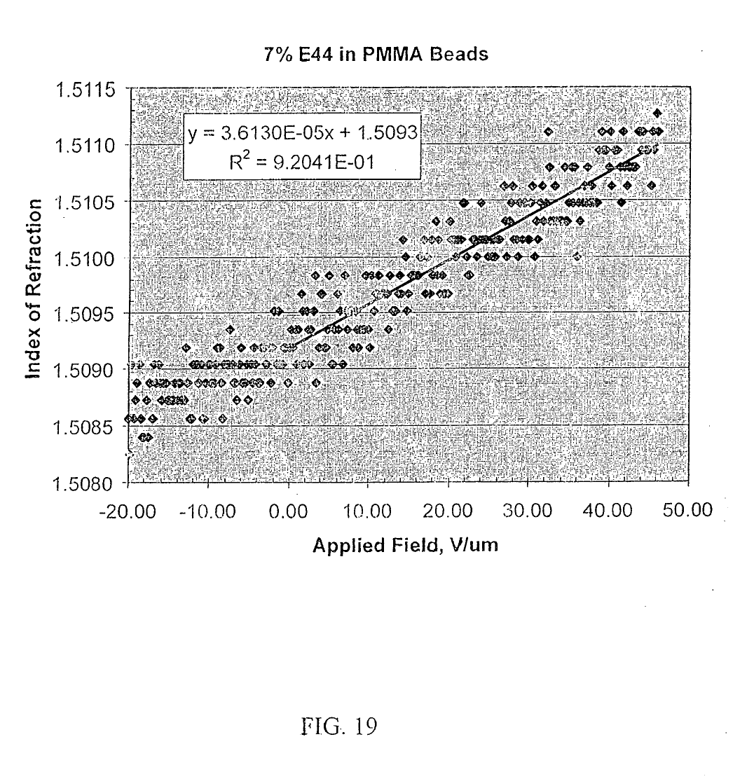

As mentioned, it is assumed that the shift in dielectric constant is a result of the orientation of the liquid crystal substance which can be resolved into a change of refractive index. To show that the change in capacitance is related to the liquid crystal substance, a series of experiments are conducted in which either the amount of the liquid crystal substance in the nano-domain is adjusted or the total amount of the liquid crystal substance in the film is reduced by mixing 22 wt. percent liquid crystal nano-domain with PMMA. Again, C-V sweeps are used to measure the capacitance response versus electric field for these samples plotted in FIG. 16-19.

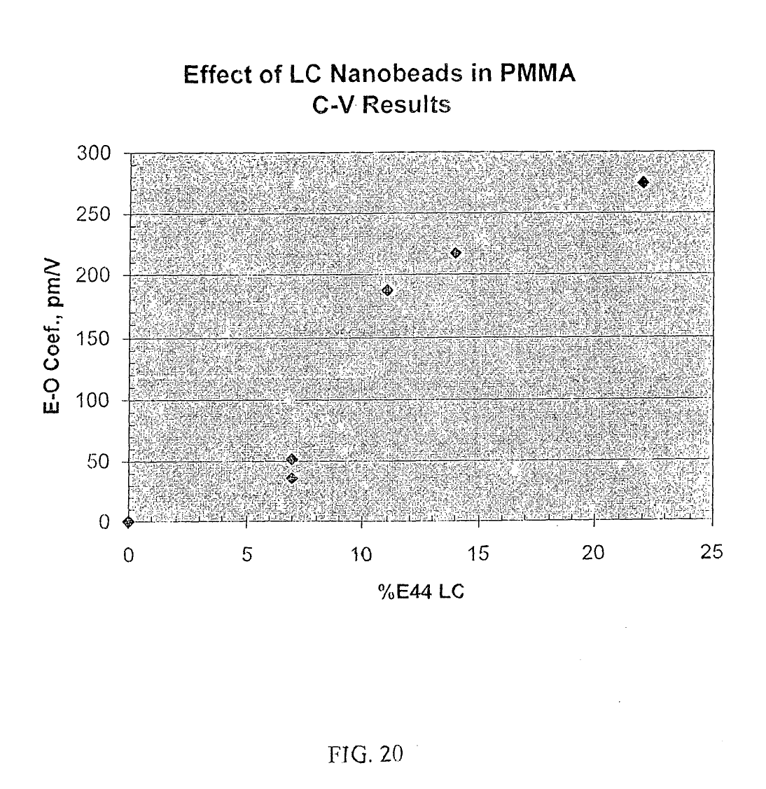

Using FIGS. 15-19 the slope of the refractive index versus electric field from 0 to 20 V/um is determined. This slope is termed the 1^{St} electro-optical coefficient. FIG. 20 shows a plot of the measured E-O coefficient versus effective Licristal® E44 percent. As shown, the E-O coefficient increases with increasing weight percent of Licristal® E44 strongly suggesting that the observed capacitance change is indeed due to the orientation of the liquid crystal molecules in the nano-dispersed domains.

Small Scale Functional Material with Imbibed Dyes Useful for Ink-Jet Printing

Ink solutions used for Ink-Jet printing need to be color stable, film formers, quick to dry, and not prone to running or bleeding under normal use conditions. In addition, particles used in the ink solutions typically have a size limit (e.g., a maximum dimension) of below 100 nm. Particles larger than this size limit can increase the likelihood of clogging the Ink-Jet cartridge during the printing process. In addition, ink solutions also need to be formulated for continuous operation in an Ink-Jet printer.

To illustrate the ability of the small scale functional material of the present disclosure to be useful as a component in an ink solution, a dye is imbibed substantially throughout the cross-linked polymer domain of the nano-domain. For the experiment, a solution of 2 wt. percent Red Dye No. 1 [CAS 3564-09-8] in methylene chloride is formed in a glass container. An aqueous dispersion of the nano-domains is weighed and added to the solution to form a mixture. The mixture is shaken at room temperature (about 21° C.) overnight. The aqueous dispersion of nano-domains remains stable substantially throughout the mixing, shaking, and decanting processes within the operational ranges; e.g., there is no precipitation of the nano-domains.

The mixture is allowed to phase separate for three hours at room temperature (about 21° C.). Two phases evolve in the container: a methylene chloride rich phase at the bottom of the container, and an aqueous phase on top. The aqueous phase is decanted and freeze-dried to obtain the nano-domains imbibed with the dye. The resulting nano-domains imbibed with the dye has the appearance of a fluffy powder.

In order to illustrate that the dye is imbibed in the small scale functional material, the surfactant (used during the formation of the nano-domains, as discussed above) is removed by the addition of a small amount of acetone. After adding the acetone, the small scale functional material precipitates from solution, leaving the solution clear. This result confirms that the dye molecule is imbibed into the nano-domain to produce the small scale functional material.

The small scale functional material with the imbibed dye can be freeze dried or spray dried. The resulting powered small scale functional material can be incorporated into an ink solution for use in Ink-Jet printing. By selecting suitable monomers to form the nano-domains (e.g., tuning the glass transition temperature), the Tg of the nano-domains can be high enough to both ensure that the imbibed dye remains entrapped in the small scale functional material, and that the thermal deflection inherent to thermal Ink-Jet printing does not disrupt the nano-domain and dislodge the imbibed dye.

Light Emitting Diode with Small Scale Functional Material and Gradient Index Layering

A light emitting diode (LED) is a semiconductor diode that emits a narrow-spectrum of light when electrically biased. The LED typically has an inherently high dielectric constant and a correspondingly high refractive index (ca. refractive index=2.4 to 3.6). The LED is usually encapsulated by a relatively low refractive index thermosetting polymer (e.g., an epoxy) or a thermoplastic. The difference in refractive indexes of the LED and the encapsulant provides a refractive index mismatch between these materials that can create a significant internal reflection called a Fresnel reflection (the reflection of a portion of incident light at a discrete interface between two media having different refractive indices). One way to limit the Fresnel reflection in an LED is to raise the refractive index value of the encapsulant material relative the refractive index value of the LED.

For the present example, it is proposed that a multi-layer gradient refractive index film encapsulate the LED. Each layer of the multi-layer gradient refractive index film can contain a small scale functional material that can, either by itself or with other components, impart a refractive index value that is slightly different that the refractive index value of an adjacent layer. Using this approach, the multi-layer gradient refractive index film can provide a nearly continual gradient of refractive indices from a relatively high value for the LED to a relatively lower value at an outermost surface of multi-layer gradient refractive index film so as to maximize light efficiency of the LED. In addition, the multi-layer gradient refractive index film can also help to minimize the Fresnel reflection for the LED encapsulated by the multi-layer gradient refractive index film.

For example, an LED package that encapsulates the LED can be formed from a multi-layer gradient refractive index film that includes ten (10) layers. For each of the ten layers the refractive index value can vary by a predetermined amount (e.g., by about 0.2 to about 0.3 refractive index units). This type of multi-layer gradient refractive index film can be created by spray coating the small scale functional materials of each layer onto an existing LED package. Alternatively, multi-layer gradient refractive index film can be integrated into the formation of the LED package.

Because of the continual gradient of refractive indices formed by this multi-layer film, the multi-layer gradient refractive index film can potentially improve the light efficiency of the LED from about 88 percent to about 95% based on reducing Fresnel-type internal reflections that would otherwise occur due to refractive index mis-match between components of the LED (esp. glass to plastic transitions). This type of gain in light efficiency is significant for power consumption and heat generation in LED based devices.

Examples of materials that are useful for imbibing to form a small scale functional material to effect a lowering of the refractive index of a layer of the multi-layer gradient refractive index film include: air, octane, octene, nonane, decane, dodecane, and other hydrocarbons and fluorinated or perfluorinated hydrocarbons. Examples of materials that are useful for imbibing to form a small scale functional material to effect a raising of the refractive index of a layer of the multi-layer gradient refractive index film include: liquid crystal substances, high dielectric constant organic liquids like bromo-naphthalene, aniline, anisole, benzaldehyde, benzonitrile, benzophenone, benzylamine, biphenyl, bromoanaline, bromoctadecane, bromohexadecane, bromoundecane, camphanedione, cycloheptasiloxane, decanol, glycerol, glycol, hexanone, lactic acid, m-nitrotoluene, maleic anhydride, methoxyphenol, quinoline, and valeronitrile.

The complete disclosures of all patents, patent applications including provisional patent applications, publications, and electronically available material cited herein or in the documents incorporated herein by reference. The foregoing detailed description and examples have been provided for clarity of understanding only. No unnecessary limitations are to be understood therefrom. The embodiments of the disclosure are not limited to the exact details shown and described; many variations will be apparent to one skilled in the art and are intended to be included within the disclosure defined by the claims.

1. A small scale functional material, comprising:
a particle having a cross-linked polymer domain with a volume mean diameter of 5 nm to 175 nm; and
a material functionally responsive to an externally applied field dispersed throughout the particle and being present from about 6 percent by weight to about 60 percent by weight.

2. The material of claim 1, where the material functionality responsive to the externally applied field is an optically-active functional material responsive to an applied field.

3. The material of claim 2, where the optically-active functional material is selected from the group of a liquid crystal substance, a dichroic dye, and combinations thereof.

4. The material of claim 3, where the liquid crystal substance includes a liquid crystal with a negative dielectric anisotropy.

5. (canceled)

6. The material of claim 2, where the optically-active functional material has a refractive index value that is greater than the refractive index value of the cross-linked polymer domain.

7. The material of claim 2, where the optically-active functional material functions to prevent transmittance of at least a portion of light in at least one of an infrared, a visible, and an ultraviolet frequency range through the small scale functional material.

8. The material of claim 1, where the cross-linked polymer domain is formed from monomers of methyl methacrylate, styrenes, butyl acrylate, and mixtures thereof.

9. (canceled)

10. A process for the preparation of a small scale functional material, comprising:
forming an emulsion of particles, where each of the particles has a cross-linked polymer domain with a volume mean diameter of 5 nm to 175 nm; and
imbibing a material functionally responsive to an externally applied field substantially throughout the cross-linked polymer domain of the particles to form the small scale functional material.

11. The process of claim 10, where imbibing the material includes imbibing an optically-active functional material responsive to an applied field substantially throughout the cross-linked polymer domain of the particles.

12. The process of claim 11, where the optically-active functional material has a refractive index value that is greater than the refractive index value of the cross-linked polymer domain.

13. The process of claim 10, where forming the emulsion includes an emulsion polymerization of monomers of methyl methacrylate, styrene, butyl acrylate, and mixtures thereof.

14. The process of claim 10, including increasing a crosslink density of the cross-linked polymer domain of the small scale functional material after imbibing the optically-active functional material substantially throughout the cross-linked polymer domain of the particles.

15. The process of claim 10, where increasing the crosslink density includes forming non-spherical particles.

16. The process of claim 10, including chemically-linking the material to the cross-linked polymer domain of the particles.

17. A composite material, comprising:
a matrix material; and
a small scale functional material dispersed in the matrix material, where the small scale functional material includes particles having a cross-linked polymer domain with a volume mean diameter from about 5 nanometers (nm) to about 175 nm and an optically-active functional material responsive to an externally applied field dispersed throughout the particles.

18. The composite material of claim 17, where the optically-active functional material responds to the externally applied field independent of the polymeric matrix material.

19. The composite material of claim 17, where the optically-active functional material in the small scale function material has a state that changes when the externally applied field is applied to the matrix material.

20. The composite material of claim 17, where the small scale functional material is dispersed spatially with varying concentration in the matrix material to create a gradient of refractive indexes in the matrix material.

21. (canceled)

22. The composite material of claim 17, where the composite material can form a film of one or more layers.

23. The composite material of claim 17, where the optically-active functional material maintains an essentially stable concentration in the cross-linked polymer domain when dispersed in the matrix material.

24.-26. (canceled)
